(19) United States
(12) Patent Application Publication
(10) Pub. No.: US 2025/0038247 A1
(43) Pub. Date: Jan. 30, 2025

(54) MANUFACTURING METHOD OF ELECTRODE PLATE GROUP FOR BATTERY AND MANUFACTURING APPARATUS OF ELECTRODE PLATE GROUP FOR BATTERY

(71) Applicant: FUJIFILM Corporation, Tokyo (JP)

(72) Inventor: Shinji IMAI, Kanagawa (JP)

(73) Assignee: FUJIFILM Corporation, Tokyo (JP)

(21) Appl. No.: 18/916,691

(22) Filed: Oct. 15, 2024

Related U.S. Application Data
(63) Continuation of application No. PCT/JP2023/016667, filed on Apr. 27, 2023.

(30) Foreign Application Priority Data
Apr. 28, 2022 (JP) 2022-074775

(51) Int. Cl. H01M 10/04

(52) U.S. Cl. CPC H01M 10/0486; H01M 10/0404; H01M 10/0468

(57) ABSTRACT

Provided are a manufacturing method including a step of alternately placing positive and negative electrode plates, each having a positioning hole, with solid electrolyte layers interposed therebetween to be temporarily positioned, thereby obtaining a temporarily laminated electrode plate group in which the positioning holes communicate with each other, and a step of inserting a positioning pin into the communication hole, in which the positioning holes communicate with each other, while restricting a variation in a lamination direction, thereby performing main positioning of the electrode plates, and a manufacturing apparatus including an electrode plate group accommodation frame that accommodates positive and negative electrode plates in a state of being alternately laminated with the solid electrolyte layers interposed therebetween, to temporarily position the electrode plates and obtain a temporarily laminated electrode plate group in which positioning holes communicate with each other, a positioning jig on which a positioning pin is erected, and a restricting member that has a pin receiving portion that is provided in a restricting portion that restricts a variation in a lamination direction of a communication hole in which the positioning holes communicate with each other.

### CROSS-REFERENCE TO RELATED APPLICATIONS

This application is a Continuation of PCT International Application No. PCT/JP2023/016667 filed on Apr. 27, 2023, which claims priority under 35 U.S.C. § 119 (a) to Japanese Patent Application No. 2022-074775 filed in Japan on Apr. 28, 2022. Each of the above applications is hereby expressly incorporated by reference, in its entirety, into the present application.

### BACKGROUND OF THE INVENTION

### 1. Field of the Invention

The present invention relates to a manufacturing method of an electrode plate group for a battery and a manufacturing apparatus of an electrode plate group for a battery.

### 2. Description of the Related Art

A lamination type secondary battery includes an electrode plate group for a battery having a structure in which electrode plates of different polarities (negative electrode plates and positive electrode plates) are alternately laminated through electrolyte layers. Such a secondary battery can achieve a high energy density and is thus expected to be applied to electric vehicles, large-sized storage batteries, and the like.

By the way, in order to prevent the occurrence of a short circuit of the assembled secondary battery, it is important that, for example, as shown in FIG. 2B, overlapping positions of active material layers in a plane direction coincide with each other between the negative electrode plates and the positive electrode plates in the electrode plate group for a battery, in other words, a projection region of positive electrode active material layers and a projection region of negative electrode active material layers in a projection view of the electrode plate group for a battery from above in a lamination direction. In a case where the electrode plate with the deviated overlapping position protrudes from the overlapping position of the other electrode plate, not only is an overlapping area of the electrode plates reduced, resulting in a decrease in energy density, but also a serious problem is incurred that the active material is likely to be precipitated on the negative electrode plate, for example, lithium in a case of a lithium ion secondary battery, leading to a short circuit.

Therefore, in a case of manufacturing the lamination type secondary battery (electrode plate group for a battery), it is required to accurately position and laminate both electrode plates in order to allow the overlapping positions of the active material layers to coincide with each other.

Meanwhile, in secondary batteries, a technology is commonly used in which dimensions (surface area of a main surface) of a negative electrode plate (negative electrode active material layer) are made larger than those of a positive electrode plate (positive electrode active material layer) to suppress the occurrence of a short circuit. In a case of adopting such a technology, since the dimensions of the electrode plates to be laminated are different, even in a case where the electrode plates are positioned based on a corner portion or an edge of the electrode plate, the electrode plates cannot be laminated while an overlapping position (projection region) of the positive electrode active material layer is located within an overlapping position (projection region) of the negative electrode active material layer.

Therefore, a method of alternately laminating positive electrode plates and negative electrode plates each having a positioning hole with a separator or a solid electrolyte layer interposed therebetween while inserting a positioning pin erected on a lamination stage into the positioning holes one by one, and an apparatus capable of performing the method have been proposed (JP2001-297755A, JP2000-260478A, JP2003-045739A (JP-H11-045739A), and JP2011-165620A). For example, JP2001-297755A discloses “a method of combining electrodes in which electrodes having different polarities are alternately stacked, the method including: transferring, from each electrode magazine in which a number of electrodes having the same polarity are held in a laminated state and electrodes having different polarities are arranged to be alternately located along a movement path of a jig, the electrodes sequentially onto the jig that is being moved; and laminating the electrodes while positioning the electrodes with respect to each other by a positioning pin erected on the jig”.

### SUMMARY OF THE INVENTION

As in the lamination method described above, the method of positioning electrode plates one by one and laminating the electrode plates enables accurate positioning of the electrode plates and facilitates lamination with high overlapping accuracy, but has a problem in that a work of laminating a predetermined number of electrode plates is complex and requires a long period of time. For example, in Example 1 of JP2000-260478A, it is described that it takes 28 minutes to laminate eight positive electrodes and nine negative electrodes with a separator interposed therebetween.

An object of the present invention is to provide a manufacturing method and a manufacturing apparatus capable of manufacturing an electrode plate group for a battery to be assembled into an all-solid state secondary battery by laminating a plurality of electrode plates within a shortened lamination time while maintaining high overlapping accuracy.

As a result of various studies, the present inventors have found that, in a case where a plurality of electrode plates are laminated with a solid electrolyte layer interposed therebetween, first, the plurality of electrode plates provided with positioning holes are laminated to be temporarily positioned such that the positioning holes of the respective electrode plates are adjusted to be in a state of being in communication with each other, and then, overlapping positions of the plurality of electrode plates in a plane direction can be adjusted and controlled at once (collectively) by inserting a positioning pin into a communication hole that appears as a result of the temporary positioning. The present invention has been completed through further studies based on these findings.

That is, the above problems have been solved by the following means.

<1> A manufacturing method of an electrode plate group for a battery that is obtained by alternately laminating a plurality of rectangular positive electrode plates and a plurality of rectangular negative electrode plates with solid electrolyte layers interposed therebetween, the manufacturing method comprising: a step of alternately placing the rectangular positive electrode plates and the rectangular negative electrode plates, each having a positioning hole, with the solid electrolyte layers interposed therebetween to be temporarily positioned, thereby obtaining a temporarily laminated electrode plate group in which the positioning holes communicate with each other; and a step of inserting a positioning pin into a communication hole, in which the positioning holes communicate with each other, while restricting a variation in a lamination direction of one opening side of the communication hole until the positioning pin protrudes from the other opening side to the one opening side of the communication hole, thereby performing main positioning of the rectangular positive electrode plates and the rectangular negative electrode plates constituting the temporarily laminated electrode plate group.

<2> The manufacturing method according to <1>, in which, in the step of performing the main positioning, the rectangular positive electrode plates and the rectangular negative electrode plates are moved in a direction perpendicular to an insertion direction of the positioning pin by the insertion of the positioning pin to perform the main positioning.

<3> The manufacturing method according to <1> or <2>, in which the positioning pin includes a pin body portion having a diameter smaller than an inner diameter of the positioning hole, and a pointed tip portion extending from one end of the pin body portion.

<4> The manufacturing method according to <3>, in which, in the step of performing the main positioning, the pin body portion is inserted into the communication hole while being guided by the pointed tip portion.

<5> The manufacturing method according to any one of <1> to <4>, in which at least one of the rectangular positive electrode plate or the rectangular negative electrode plate used in the step of obtaining the temporarily laminated electrode plate group has a solid electrolyte layer on both main surfaces of an active material layer.

<6> The manufacturing method according to any one of <1> to <5>, in which, in the step of obtaining the temporarily laminated electrode plate group, the laminated rectangular positive electrode plates and rectangular negative electrode plates are corrected to be flat.

<7> The manufacturing method according to any one of <1> to <6>, in which the rectangular positive electrode plate and/or the rectangular negative electrode plate used in the step of obtaining the temporarily laminated electrode plate group has a base material extension portion having the positioning hole in at least one side edge on a short side of an active material layer.

<8> The manufacturing method according to <7>, in which the rectangular positive electrode plate and/or the rectangular negative electrode plate used in the step of obtaining the temporarily laminated electrode plate group has two or more base material extension portions.

<9> The manufacturing method according to <7> or <8>, in which the base material extension portion extends to both side edges on the short side of the active material layer.

<10> The manufacturing method according to any one of <1> to <9>, in which, in the step of obtaining the temporarily laminated electrode plate group, the rectangular positive electrode plates and the rectangular negative electrode plates are alternately laminated and then oscillated in a direction perpendicular to the lamination direction to assist in the temporary positioning.

<11> An manufacturing apparatus of an electrode plate group for a battery that is obtained by alternately laminating a plurality of rectangular positive electrode plates and a plurality of rectangular negative electrode plates with solid electrolyte layers interposed therebetween, the manufacturing apparatus comprising: an electrode plate group accommodation frame that has an accommodation space for accommodating the rectangular positive electrode plates and the rectangular negative electrode plates, each having a positioning hole, in a state of being alternately laminated with the solid electrolyte layers interposed therebetween, in which the rectangular positive electrode plates and the rectangular negative electrode plates are temporarily positioned by being accommodated in the accommodation space to obtain a temporarily laminated electrode plate group in which the positioning holes communicate with each other; a positioning jig that is provided to be relatively movable forward or rearward in a lamination direction of the temporarily laminated electrode plate group and on which a positioning pin that is inserted into the positioning hole is erected; and a restricting member that is relatively movable to a position facing the positioning jig across the electrode plate group accommodation frame, that is provided to be relatively movable close to and away from the positioning jig, and that has a restricting portion that restricts a variation in the lamination direction of one opening side of a communication hole in which the positioning holes communicate with each other, and a pin receiving portion that is provided in the restricting portion and receives the positioning pin.

<12> The manufacturing apparatus according to <11>, further comprising: an electrode plate transport device that transports the rectangular positive electrode plates and rectangular negative electrode plates alternately into the accommodation space with the solid electrolyte layers interposed therebetween; and a frame transport device that transports the electrode plate group accommodation frame between the positioning jig and the restricting member.

<13> The manufacturing apparatus according to <11> or <12>, in which the positioning pin includes a pin body portion having a diameter smaller than an inner diameter of the positioning hole, and a pointed tip portion extending from one end of the pin body portion.

<14> The manufacturing apparatus according to any one of <11> to <13>, in which at least one of the rectangular positive electrode plate or the rectangular negative electrode plate accommodated in the electrode plate group accommodation frame has a solid electrolyte layer on both main surfaces of an active material layer.

<15> The manufacturing apparatus according to any one of <11> to <14>, further comprising: a correction member that corrects the laminated rectangular positive electrode plates and rectangular negative electrode plates to be flat.

<16> The manufacturing apparatus according to any one of <11> to <15>, in which the rectangular positive electrode plate and/or the rectangular negative electrode plate accommodated in the electrode plate group accommodation frame has a base material extension portion having the positioning hole in at least one side edge on a short side of an active material layer.

<17> The manufacturing apparatus according to <16>, in which the rectangular positive electrode plate and/or the rectangular negative electrode plate accommodated in the electrode plate group accommodation frame has two or more base material extension portions.

<18> The manufacturing apparatus according to <16> or <17>, in which the base material extension portion extends to both side edges on the short side of the active material layer.

<19> The manufacturing apparatus according to any one of <11> to <18>, further comprising: an oscillating device that oscillates the electrode plate group accommodation frame in a direction perpendicular to the lamination direction of the rectangular positive electrode plates and the rectangular negative electrode plates.

With the manufacturing method and the manufacturing apparatus of an electrode plate group for a battery according to an embodiment of the present invention, a plurality of electrode plates can be laminated within a short lamination time while maintaining (controlling) high overlapping accuracy, and the electrode plate group for a battery can be manufactured with high accuracy and high productivity.

The above-described and other characteristics and advantages of the present invention will be further clarified by the following description with appropriate reference to the accompanying drawing.

### BRIEF DESCRIPTION OF THE DRAWINGS

FIGS. 1A to 1C are schematic views showing a preferred embodiment of an electrode plate used in the present invention. FIG. 1A is a schematic top view showing the preferred embodiment of the electrode plate, FIG. 1B is a schematic front view showing the preferred embodiment of the electrode plate, and FIG. 1C is a schematic front view showing a preferred embodiment of an electrode plate with an electrolyte layer.

FIGS. 2A and 2B are schematic views showing a preferred embodiment of an electrode plate group for a battery in the present invention. FIG. 2A is a schematic top view showing the preferred embodiment of the electrode plate group for a battery, and FIG. 2B is a schematic front view showing the preferred embodiment of the electrode plate group for a battery.

FIGS. 3A and 3B are schematic overall views showing a suitable embodiment of a manufacturing apparatus of the electrode plate group for a battery of the present invention. FIG. 3A is a schematic top view showing the suitable embodiment of the manufacturing apparatus of the electrode plate group for a battery according to the present invention, and FIG. 3B is a schematic left side view showing the suitable embodiment of the manufacturing apparatus of the electrode plate group for a battery of the present invention.

FIG. 4 is a schematic front view schematically showing a state in which a frame is disposed under an opening and closing shutter in the suitable embodiment of the manufacturing apparatus of the electrode plate group for a battery of the present invention.

FIG. 5 is a schematic front view schematically showing an electrode plate group accommodation frame, a positioning jig, and a restricting member in the suitable embodiment of the manufacturing apparatus of the electrode plate group for a battery of the present invention.

FIGS. 6A and 6B are schematic front views showing a suitable embodiment of a positioning pin to be erected on a positioning jig.

### DESCRIPTION OF THE PREFERRED EMBODIMENTS

In the present invention, “positioning” refers to adjusting overlapping positions (lamination positions) of electrode plates, and is usually performed by displacing the electrode plates in a plane direction (a longitudinal direction and a lateral direction) of the electrode plates. The “positioning” includes “temporary positioning” in which the positioning is roughly performed to the extent that positioning holes communicate with each other and a communication hole appears, and “main positioning” in which the overlapping positions (the positions of the electrode plates in the plane direction, a positional deviation, and the like) of positive electrode active material layers and negative electrode active material layers in the temporarily positioned electrode plates are adjusted (corrected) with high accuracy so that one active material layer does not protrude from the other active material layer, usually so that (a projection region of) the positive electrode active material layer does not protrude from (a projection region of) the negative electrode active material layer. Here, “high accuracy” (also referred to as high overlapping accuracy) means that the overlapping positions are adjusted to the extent that one active material layer does not protrude from the other active material layer, usually that positive electrode active material layer does not protrude from the negative electrode active material layer. Specifically, although the overlapping accuracy cannot be determined uniquely depending on dimensions of the electrode plates (active material layers), a difference in dimensions between the positive electrode active material layer and the negative electrode active material layer, a difference in diameter between the positioning hole and the positioning pin, and the like, overlapping accuracy (clearance) in examples described below can be 3.0 mm or less, preferably 2.0 mm or less, more preferably 1.0 mm or less, and even more preferably 0.5 mm or less.

In the present invention, “positioning holes communicate with each other” includes, according to perforation positions and the number of perforations of the positioning holes, both an aspect in which all the positioning holes perforated in the negative electrode plate, the positive electrode plate, and a solid electrolyte layer in some aspects are caused to communicate with each other in a lamination direction, and an aspect in which the positioning hole perforated in the negative electrode plate is caused to separately communicate with the positioning hole perforated in the positive electrode plate, and the positioning hole perforated in the positive electrode plate is caused to separately communicate with the positioning hole perforated in the negative electrode plate. That is, the aspect in which the positioning holes are caused to communicate with each other includes a first aspect in which a plurality of the positioning holes arranged in a line along the lamination direction of the electrode plates are caused to communicate with each other regardless of kinds of the electrode plates, and a second aspect in which a plurality of the positioning holes arranged in a line along the lamination direction of the electrode plates are caused to communicate with each other for each electrode plate. In the first aspect, the plurality of positioning holes arranged in a line along the lamination direction among the positioning holes perforated in the negative electrode plate, the positive electrode plate, and the solid electrolyte layer in some aspects communicate with each other. On the other hand, in the second aspect, the plurality of positioning holes arranged in a line along the lamination direction among the positioning holes perforated in the electrode plates having the same polarity are caused to communicate with each other, and the positioning holes perforated in the electrode plates having different polarities do not communicate with each other.

In the present invention, “main surface” refers to a surface perpendicular to a thickness direction in a flat plate body such as an electrode plate, and usually refers to a surface having the largest surface area.

In addition, with regard to the electrode plate or the like, “plane direction” means an in-plane direction of the main surface, specifically, a longitudinal direction and a lateral direction.

In the present invention, in a case where a numerical value range is shown to describe a content, physical properties, or the like of a component, any upper limit value and any lower limit value can be appropriately combined to obtain a specific numerical value range in a case where an upper limit value and a lower limit value of the numerical value range are described separately. On the other hand, in a case where a plurality of numerical value ranges are set to describe a numerical value range represented by using “to”, an upper limit value and a lower limit value, which form each of the numerical value ranges, are not limited to a specific combination, and can be set to a numerical value range obtained by appropriately combining the upper limit value and the lower limit value of each numerical value range. In addition, in the present invention, a numerical range represented by using “to” means a range including numerical values described before and after “to” as a lower limit value and an upper limit value.

Preferred aspects of a manufacturing method and a manufacturing apparatus according to an embodiment of the present invention will be specifically described below, but the present invention is not limited to the preferred aspects.

### [Electrode Plate]

First, an electrode plate used in the embodiment the present invention will be described.

In the present invention, as the electrode plate, a rectangular positive electrode plate and a rectangular negative electrode plate (sometimes simply referred to as a positive electrode plate or a negative electrode plate) are used. Therefore, in the present invention, the term “electrode plate” refers collectively to the positive electrode plate and the negative electrode plate, unless otherwise specified.

In addition, the “electrode plate” used in the present invention may be changed in shape, structure, and the like during manufacturing or after manufacturing in the manufacturing method according to the embodiment of the present invention, and may be the same as or different from “electrode plates” constituting an electrode plate group for a battery manufactured by the manufacturing method of the present invention. In the present invention, in a case where both are distinguished from each other, the “electrode plate” used in the present invention is sometimes referred to as an “electrode plate for lamination”, and the “electrode plates” constituting the electrode plate group for a battery are sometimes referred to as “laminated electrode plates”.

The electrode plate used in the present invention has a rectangular thin plate shape in a plan view and has at least one positioning hole.

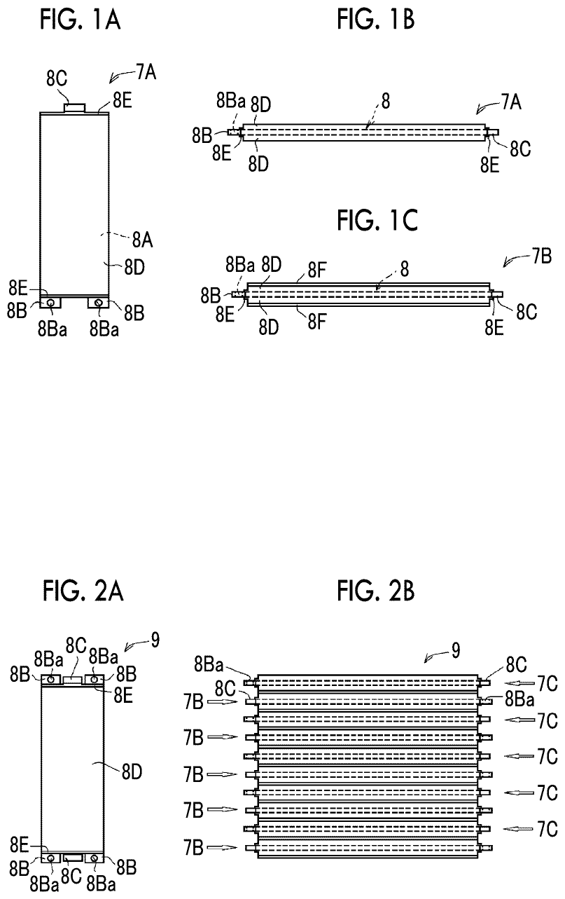

As shown in FIG. 1, the electrode plate for lamination has a thin plate shape having a rectangular shape, preferably a rectangular shape, in a plan view for at least a region where an active material layer is formed. In the present invention, “rectangular” means a quadrangular shape including a square and a rectangle. However, “rectangular” is not limited to a geometrically accurate quadrangular shape as long as the shape functions as an electrode plate of an electrode plate group for a battery (all-solid state secondary battery), and may be a substantially quadrangular shape depending on an application, required characteristics, and the like. In addition, “rectangular” may also be a shape in which a corner portion is chamfered.

The electrode plate for lamination has at least one positioning hole. A shape of the positioning hole is preferably similar to a cross-sectional shape of the positioning pin, which will be described later, perpendicular to an axis, and can be, for example, a circular shape, an elliptical shape, a polygonal shape, or a star shape, and preferably a circular shape. An inner diameter of the positioning hole is not particularly limited, and is appropriately determined according to dimensions of an electrode plate group accommodation frame, a size of the electrode plate, and the like, so that a communication hole is formed by the temporary positioning. As an example, the inner diameter of the positioning hole can be set to, for example, 1.0 to 6.0 mm. From the viewpoint of overlapping accuracy, a difference between the inner diameter of the positioning hole and an outer diameter of the pin body portion of the positioning pin is preferably 0.01 to 0.5 mm.

In the electrode plate for lamination, a position (positioning hole formation region) where the positioning hole is provided may be any position (region) of the electrode plate for lamination, and from the viewpoint of overlapping accuracy or the like, the position is preferably in the vicinity of an end edge of the active material layer or in a corner portion of the electrode plate for lamination (including a base material extension portion described below). The number of positioning holes in one electrode plate for lamination is appropriately determined depending on the shape of the positioning hole, the positioning method, the overlapping accuracy, and the like, and from the viewpoint of the overlapping accuracy, the number of positioning holes in one electrode plate for lamination is preferably two or more and more preferably two to five. In a case where the shape of the positioning hole is a polygonal shape, a star shape, or the like, one positioning hole may be provided. In a case where one electrode plate for lamination has a plurality of positioning holes, a formation position of each positioning hole is not particularly limited, but it is preferable that the formation position is not close to one corner portion or the like, for example, it is preferable that the formation position is provided on each of a plurality of end edge sides, and it is more preferable that the formation position is provided on each of a plurality of corner portions. In this case, a shortest distance between the positioning holes can be appropriately determined according to the dimensions of the electrode plate for lamination, and for example, in a case of the electrode plate for lamination having dimensions described below, the shortest distance can be set to 15 to 100 mm.

As shown in FIG. 1, the electrode plate for lamination has active material layers having the same polarity on both main surfaces thereof. An electrode plate having a positive electrode active material layer is referred to as a positive electrode plate, and an electrode plate having a negative electrode active material layer is referred to as a negative electrode plate.

The electrode plates used in the present invention may be the same or different in terms of shape and positioning holes, for example, and it is preferable that the positive electrode plate and the negative electrode plate are the same.

The electrode plate for lamination usually has a base material and active material layers disposed on both main surfaces of the base material. As the base material, any material used as a current collector of an all-solid state secondary battery can be used without restriction, and a (thin) metal sheet made of aluminum, an aluminum alloy, copper, a copper alloy, stainless steel, nickel, iron, titanium, or the like is used. The active material layer can be used as an active material layer of the all-solid state secondary battery without particular limitation, and usually contains an active material and, as appropriate, an inorganic solid electrolyte, a conductive auxiliary agent, a binder, and other additives. Each of substances constituting the active material layer is not particularly limited, and each normal components can be used. For example, the active material may be an electrode active material used for a secondary battery, and examples thereof include a positive electrode active material and a negative electrode active material.

In the present invention, as the electrode plate for lamination, an electrode plate having a positioning hole at a position where the positioning holes of at least the electrode plates having the same polarity communicate with each other in a case of being laminated is used. In this case, the positioning holes communicating with each other are disposed and arranged on a line along the lamination direction of the electrode plates. In the present invention, depending on a perforation position of the positioning hole of the electrode plate for lamination, as the positive electrode plate and the negative electrode plate, electrode plates having the positioning holes at the same position, for example, electrodes plates having the positioning holes in some portions disposed and arranged on the same line along the lamination direction in a case of being laminated can also be used.

The dimensions (a length and a width of the main surface) of the electrode plate are not particularly limited, and can be appropriately determined according to the application, required characteristics, and the like. For example, the rectangular electrode plate can have a short side of 40 to 200 mm and a long side of 100 to 600 mm in the active material layer. In the present invention, from the viewpoint of preventing a short circuit, it is preferable that the dimensions of the negative electrode active material layer of the negative electrode plate are set to be larger than the dimensions of the positive electrode active material layer of the positive electrode plate, and in the positive and negative electrode active material layers, a difference in dimension between the long sides can be set to 0.5 to 6 mm, and a difference in dimension between the short sides can be set to 0.5 to 6 mm. In this range, a decrease in energy density in a case of being used as a battery can also be suppressed.

A thickness of the base material (particularly, the active material layer formation region) is not particularly limited, and can be appropriately determined according to the application, required characteristics, even strength (prevention of damage to the positioning hole), and the like. For example, the thickness of the base material can be set to 5 to 30 μm.

A thickness of the active material layer (provided on one main surface of the base material) is not particularly limited and can be appropriately determined according to the application, required properties, and the like. For example, the thickness of the active material layer can be set to 30 to 300 μm.

The electrode plate for lamination may be a rectangular electrode plate having a positioning hole, and an appropriately changed electrode plate can be used.

An electrode plate for lamination, which is a preferred embodiment of the electrode plate for lamination, is shown in FIGS. 1A and 1B.

An electrode plate 7A for lamination has a base material 8 having a rectangular active material layer formation region 8A in a plan view, a pair of base material extension portions (also referred to as tabs) 8B that are provided extend from vicinities of both ends (long side end edges) of one short side end edge to protrude in a substantially rectangular shape, and a lead portion 8C that is provided to extend from a substantially center of the other short side end edge to protrude in a substantially rectangular shape, and an active material layer 8D provided on both main surfaces of the active material layer formation region 8A. The lead portion 8C is a member which serves as a lead tab in an electrode plate group for a battery and an all-solid state secondary battery. One circular positioning hole 8Ba is perforated in each of substantially center portions of the pair of base material extension portions 8B. Dimensions of the base material extension portion 8B and the lead portion 8C are appropriately determined.

The active material layer 8D is formed on both main surfaces of the active material layer formation region 8A. On each of the short side end edges of the active material layer 8D, an insulating portion 8E that seals the end edge (end surface) with an insulating resin in order to prevent a short circuit with other laminated electrode plates is formed along the short side.

The base material extension portion 8B and the lead portion 8C of the electrode plate 7A for lamination are not provided with an insulating portion, but an insulating portion can also be provided from the viewpoint of preventing a short circuit.

The electrode plate for lamination can also be in a form in which the above-described electrode plate 7A for lamination is appropriately changed.

For example, in the electrode plate 7A for lamination, the base material extension portion 8B and the lead portion 8C are provided on the short side end edge of the active material layer formation region 8A, but in the present invention, an electrode plate for lamination in which a base material extension portion and a lead portion are provided on a long side end edge of a base material can also be used.

In addition, in the electrode plate 7A for lamination, the pair of (two) base material extension portions 8B (positioning holes 8Ba) are provided on the one short side end edge of the active material layer formation region 8A, but in the present invention, an electrode plate for lamination in which one base material extension portion (positioning hole) is provided on one short side end edge of an active material layer formation region or an electrode plate for lamination in which three or more base material extension portions (positioning holes) can also be used.

Furthermore, in the electrode plate 7A for lamination, the pair of base material extension portions 8B are provided on the one short side end edge side of the active material layer formation region 8A, but in the present invention, an electrode plate for lamination in which a pair of base material extension portions are provided on each of short side end edges of an active material layer formation region can also be used. As described above, in a case where the electrode plate for lamination having a total of four base material extension portions is used, the positioning pins can be inserted while reducing a load on the base material extension portions and the positioning holes, and a higher overlapping accuracy can be achieved.

In addition, in the electrode plate 7A for lamination, the positioning hole 8Ba is perforated in the base material extension portion 8B, but in the present invention, an electrode plate for lamination in which a positioning hole is provided in an active material layer or a lead portion without providing a base material extension portion can also be used. In this case, in a case where a plurality of positioning holes are perforated, at least one positioning hole can be perforated in the base material extension portion or the lead portion, and the remaining positioning holes can be perforated in the active material layer.

The insulating portion can be provided at a location where the electrode plates can be short-circuited (brought into contact) with each other, and can be provided, for example, at an inside (inner surface) of the positioning hole, in addition to the base material extension portion and the lead portion.

The number of the positioning holes can also be appropriately changed.

For example, the number of positioning holes to be perforated in one corner portion (including the base material extension portion) may be at least one, and can be two or more. In consideration of workability, overlapping accuracy, and the like, the number of positioning holes to be perforated in one corner portion is preferably one or two. In a case where two or more positioning holes are perforated, dispositions thereof are not particularly limited, and examples thereof include a disposition in which the two or more positioning holes are arranged in parallel along a short side direction or a long side direction of the base material.

In the present invention, it is preferable that one electrode plate of the positive electrode plate and the negative electrode plate used as the electrode plate 7A for lamination has the base material extension portion. However, in a more preferable aspect, the electrode plates for lamination of both the positive electrode plate and the negative electrode plate have the base material extension portion, and in a more preferable aspect, the positive electrode plate has the base material extension portion while the negative electrode plate does not have the base material extension portion. The electrode plate having the base material extension portion can also adopt the above-described modified forms. In the electrode plate that does not have the base material extension portion, the positioning hole 8Ba is provided in the active material layer or the lead portion, as will be described later.

### [Solid Electrolyte Layer]

A solid electrolyte layer is an electron-insulating electrolyte layer disposed between the positive electrode active material layer and the negative electrode active material layer in the electrode plate group for a battery, and any solid electrolyte layer that is used as the solid electrolyte layer of the all-solid state secondary battery can be used without particular limitation.

The solid electrolyte layer can also be used as a film made of or molded of a formation material, and can also be used as a layer made on the active material layer of the electrode plate for lamination or a layer laminated and disposed (pressure-bonded) on the active material layer. From the viewpoint of manufacturing efficiency of the electrode plate group for a battery, it is preferable to use the solid electrolyte layer as a layer made on the active material layer of the electrode plate for lamination or a layer laminated and disposed on the active material layer, and it is more preferable to use the solid electrolyte layer as a layer made on the negative electrode active material layer or a layer laminated and disposed on the negative electrode active material layer from the viewpoint of preventing a short circuit or the like. Regarding a solid electrolyte layer for an all-solid state secondary battery, in the manufacturing of the electrode plate group for a battery, the solid electrolyte layer can be used as an independent film or a layer attached to the electrode plate, thereby increasing the manufacturing efficiency of the electrode plate group for a battery. Examples of the electrode plate in which the solid electrolyte layer is provided on the active material layer (sometimes referred to as an electrode plate with an electrolyte layer) include a negative electrode plate with an electrolyte layer and a positive electrode plate with an electrolyte layer. A negative electrode plate 7B with an electrolyte layer and the positive electrode plate with an electrolyte layer are the same as the electrode plate 7A, except that a solid electrolyte layer 8F is laminated on each of the main surfaces of the active material layers 8D as shown in FIG. 1C.

The solid electrolyte layer usually contains an inorganic solid electrolyte, and contains a binder and other additives as appropriate. Each of substances constituting the solid electrolyte layer is not particularly limited, and normal components can be used.

In a case where an electrode plate having a positioning hole in an active material layer is used as the electrode plate for lamination, as the solid electrolyte layer, a solid electrolyte layer having a positioning hole at a position corresponding to the positioning hole is used.

Dimensions of the solid electrolyte layer are not particularly limited, but are usually set to the same dimensions as those of the active material layer, preferably the negative electrode active material layer. A thickness of the solid electrolyte layer is not particularly limited, and can be appropriately determined according to the application, required characteristics, and the like. For example, the thickness of the solid electrolyte layer can be set to 5 to 300 μm, or can be set to 30 to 50 μm.

### [Electrode Plate Group for Battery]

Next, the electrode plate group for a battery manufactured by the manufacturing method according to the embodiment of the present invention and the manufacturing apparatus according to the embodiment of the present invention will be described.

The electrode plate group for a battery (also referred to as an electrode plate laminate for a battery) is obtained by alternately laminating a plurality of positive electrode plates and a plurality of negative electrode plates with solid electrolyte layers interposed therebetween, and has a plurality of laminated structures of a negative electrode active material layer, a solid electrolyte layer, a positive electrode active material layer, a solid electrolyte layer, a negative electrode active material layer . . . .

The number of positive electrode plates (negative electrode plates) laminated in the electrode plate group for a battery is not particularly limited, and is appropriately set according to the application, required characteristics, for example, a battery capacity, and even dimensions. The number of positive electrode plates laminated can be set to, for example, 2 to 100.

The electrode plates (laminated electrode plates) constituting the electrode plate group for a battery may be the same as or different from the electrode plate for lamination. Examples of an electrode plate different from the electrode plate for lamination include an electrode plate in which a shape, a structure, and the like of the electrode plate for lamination are appropriately changed during manufacturing or after manufacturing in the manufacturing method according to the embodiment of the present invention. More specific examples thereof include an electrode plate in which a base material extension portion of an electrode plate for lamination is cut off.

The electrode plate group for a battery may have a fixing member that fixes a laminated state of the electrode plate, and a housing (covering member) that covers the entire electrode plate.

The electrode plate group for a battery has an appropriate laminated state and shape according to the electrode plate used. For example, an electrode plate group 9 for a battery according to a preferred embodiment manufactured using the electrode plate 7A and the negative electrode plate 7B with an electrolyte layer shown in FIGS. 1A to 1C are used is shown in FIGS. 2A and 2B. The electrode plate group 9 for a battery has a structure in which five negative electrode plates 7B with an electrolyte layer, each having the solid electrolyte layer provided on the active material layer of the electrode plate 7A, and five positive electrode plates 7C corresponding to the electrode plate 7A are alternatively laminated in such a manner that the lead portions 8C of the negative electrode plates 7B with an electrolyte layer and the positive electrode plates 7C are opposite each other.

In the present invention, an electrode plate group for a battery manufactured using an electrode plate for lamination or a negative electrode plate with an electrolyte layer, which does not have the base material extension portion 8B, instead of the electrode plate 7A for lamination or the negative electrode plate 7B with an electrolyte layer is also a preferred embodiment. The electrode plate group for a battery is the same as the electrode plate group for a battery 9 shown in FIG. 2, except that the negative electrode plate 7B with an electrolyte layer does not have the base material extension portion 8B.

### [All-Solid State Secondary Battery]

An all-solid state secondary battery including the electrode plate group for a battery is the same as a known lamination type all-solid state secondary battery, and is not particularly limited, except that the electrode plate group for a battery is manufactured by the manufacturing method according to the embodiment of the present invention or the manufacturing apparatus according to the embodiment of the present invention. In a case where the electrode plate group for a battery is to be assembled, a normal assembly step such as connecting the negative electrode plates to each other to provide lead wires and enclosing the negative electrode plates in a housing is performed.

### [Manufacturing Method of Electrode Plate Group for Battery]

A manufacturing method of the electrode plate group for a battery according to the embodiment of the present invention (sometimes simply referred to as a manufacturing method according to the embodiment of the present invention) is a manufacturing method of the electrode plate group for a battery obtained by alternately laminating the plurality of rectangular positive electrode plates and the plurality of rectangular negative electrode plates with the solid electrolyte layers interposed therebetween, in which the plurality of electrode plates are temporarily positioned and thereafter collectively positioned, instead of laminating the plurality of electrode plates while positioning the plurality of electrode plates one by one. In such a manufacturing method according to the embodiment of the present invention, the plurality of electrode plates can be positioned at once while maintaining high overlapping accuracy, and high productivity can be achieved.

The manufacturing method according to the embodiment of the present invention specifically has the following step 1 and step 2.

Step 1: Step of alternately placing the rectangular positive electrode plates and the rectangular negative electrode plates having the positioning holes with the solid electrolyte layers interposed therebetween to be temporarily positioned, thereby obtaining a temporarily laminated electrode plate group in which the positioning holes communicate with each other in the lamination direction

Step 2: Step of inserting the positioning pin into the communication hole that has appeared in the step of obtaining the temporarily laminated electrode plate group while restricting a variation in the lamination direction of one opening side, usually a region where the positioning hole is perforated in the electrode plate, until the positioning pin protrudes from the other opening side to one opening side, thereby performing main positioning of the rectangular positive electrode plates and the rectangular negative electrode plates constituting the temporarily laminated electrode plate group

### [Manufacturing Apparatus of Electrode Plate Group for Battery]

A manufacturing apparatus of the electrode plate group for a battery according to the embodiment of the present invention (sometimes simply referred to as a manufacturing apparatus according to the embodiment of the present invention) has, in a manufacturing apparatus of the electrode plate group for a battery obtained by alternately laminating the plurality of rectangular positive electrode plates and the plurality of rectangular negative electrode plates with the solid electrolyte layers interposed therebetween, an electrode plate group accommodation frame described below that temporarily laminates the plurality of electrode plates such that the communication hole in which the positioning holes communicate with each other is formed, a positioning jig described below on which the positioning pin that is inserted into the communication hole to position the electrode plates is erected, and a restricting member described below that has a pin receiving portion that is provided in a restricting portion that restricts a variation in the lamination direction of one opening side of the communication hole and receives the positioning pin. The manufacturing apparatus according to the embodiment of the present invention having such a configuration can suitably implement the manufacturing method according to the embodiment of the present invention, and can achieve high productivity by positioning the plurality of electrode plates at once while maintaining high overlapping accuracy.

Electrode plate group accommodation frame: Electrode plate group accommodation frame that has an accommodation space for accommodating the rectangular positive electrode plates and the rectangular negative electrode plates having the positioning holes, in a state of being alternately laminated with the solid electrolyte layers interposed therebetween, in which the rectangular positive electrode plates and the rectangular negative electrode plates are temporarily positioned by being accommodated in the accommodation space, thereby forming the temporarily laminated electrode plate group in which the positioning holes communicate with each other

Positioning jig: Positioning jig that is provided to be relatively movable forward or rearward in the lamination direction of the temporarily laminated electrode plate group and on which the positioning pin that is inserted into the positioning hole is erected

Restricting member: Restricting member that is relatively movable to a position facing the positioning jig (the positioning pin) across the electrode plate group accommodation frame and that is provided to be relatively movable close to and away from the positioning jig, the restricting member having the restricting portion that restricts a variation in the lamination direction of one opening side of the communication hole in which the positioning holes communicate with each other, and the pin receiving portion that is provided in the restricting portion and receives the positioning pin (that passes through the positioning hole)

The manufacturing apparatus according to the embodiment of the present invention may include the above-described electrode plate group accommodation frame, the positioning jig, and the restricting member, and may also include other constituent devices (mechanisms) as appropriate, such as a transport device that transports the electrode plate for lamination into the accommodation space, a device that transports the electrode plate group accommodation frame or the positioning jig, or other constituent devices.

Hereinafter, the manufacturing method and the manufacturing apparatus according to the embodiment of the present invention will be specifically described with reference to a suitable embodiment in which the negative electrode plate 7B with an electrolyte layer and the positive electrode plate 7C are used and the electrode plates are overlapped and laminated in a horizontal direction. However, the present invention is not limited to this suitable embodiment, and encompasses, for example, an embodiment in which the plurality of the electrode plates are disposed in an upright state such that (the main surfaces of) the active material layers face each other through the solid electrolyte layers interposed therebetween, and the electrode plates are disposed to be erected in the horizontal direction and laminated.

### <Suitable Embodiment of Manufacturing Method According to Embodiment of Present Invention and Manufacturing Apparatus According to Embodiment of Present Invention>

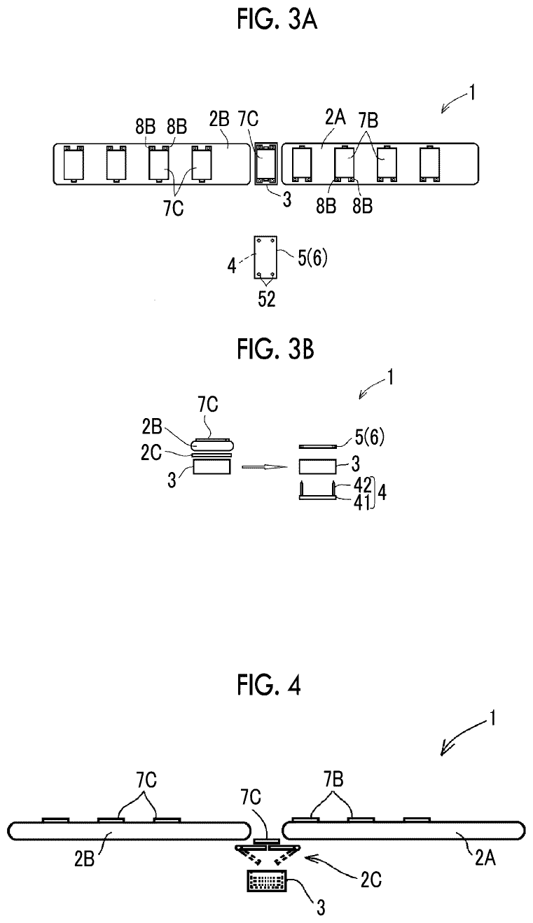

In this suitable embodiment, the electrode plate group for a battery 9 is manufactured by using a manufacturing apparatus 1 of the electrode plate group for a battery, which is a suitable embodiment of the manufacturing apparatus according to the embodiment of the present invention shown in FIGS. 3A to 5.

As shown in FIGS. 3A and 3B, the manufacturing apparatus 1 includes, along a flow of the manufacturing method, an electrode plate transport device 2, an electrode plate group accommodation frame 3, a frame transport device (not shown in FIGS. 3A and 3B), a positioning jig 4, and a restricting member 5 that is integrated with a correction member 6.

In the manufacturing apparatus 1, a direction in which the electrode plates are laminated (direction of gravity) is referred to as an up-down direction, and an advancing direction of a positioning pin 42 in this direction is referred to as an upward direction.

A configuration of the manufacturing apparatus 1 will be described in order together with a modification example thereof.

As shown in FIGS. 3A to 4, the manufacturing apparatus 1 has, as the electrode plate transport device 2 that transports the plurality of rectangular positive electrode plates and rectangular negative electrode plates alternately into the accommodation space with the solid electrolyte layers interposed therebetween, a conveyor 2A and a conveyor 2B that are disposed to face each other at an interval on a straight line, and an opening and closing shutter 2C (not shown in FIG. 3A) that is installed between the conveyor 2A and the conveyor 2B and above an accommodation space 33 of the electrode plate group accommodation frame 3. The conveyor 2A is a conveyor that intermittently transports the plurality of negative electrode plates 7B with an electrolyte layer toward the opening and closing shutter 2C, and the conveyor 2B is a conveyor that intermittently transports the plurality of positive electrode plates 7C toward the opening and closing shutter 2C in a direction opposite to the conveyor 2A. The opening and closing shutter 2C places one by one the negative electrode plates 7B with an electrolyte layer and the positive electrode plates 7C that have been alternately transported from the conveyors 2A and 2B and then opens a shutter to feed the negative electrode plates 7B with an electrolyte layer and the positive electrode plates 7C into the accommodation space 33 of the electrode plate group accommodation frame 3 located below the shutter.

The conveyors 2A and 2B are not particularly limited as long as the electrode plate 7B or 7C can be transported, and examples thereof include a known transport device, various conveyors, a robot arm, and manual transport, and a belt conveyor is preferable. In addition, the opening and closing shutter 2C is not particularly limited, and examples thereof include a known opening and closing device (mechanism), such as a shutter valve for a hopper.

In the present invention, the electrode plate transport device is not limited to the above-described aspect and can be appropriately changed. For example, a configuration can be adopted in which each of the negative electrode plates with an electrolyte layer and the positive electrode plates are directly fed into the accommodation space of the electrode plate group accommodation frame from the two conveyors without using the opening and closing shutter. In addition, a configuration can also be adopted in which the negative electrode plates with an electrolyte layer and the positive electrode plates that are alternately placed on a single conveyor are transported. In a case where the negative electrode plates with an electrolyte layer and the positive electrode plates are transported by a single conveyor, it is possible to reduce an impact in a case of feeding the electrode plates into the opening and closing shutter or the accommodation space, and it is possible to effectively prevent breakage or damage of the electrode plates. Furthermore, in a case where the negative electrode plate with an electrolyte layer is not used, a third transport device for transporting the solid electrolyte layer can also be installed. In addition, the manufacturing apparatus according to the embodiment of the present invention does not include the electrode plate transport device, and the electrode plates can also be transported manually.

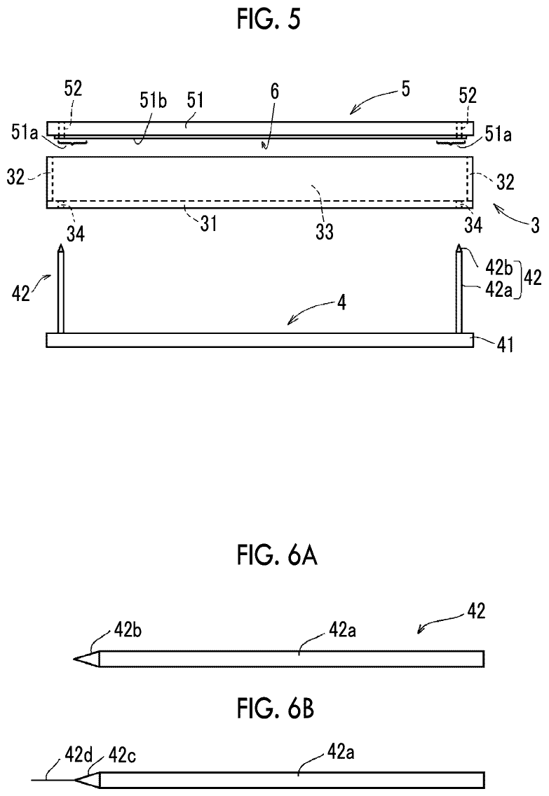

As shown in FIGS. 3A to 5, the manufacturing apparatus 1 includes the electrode plate group accommodation frame (sometimes simply referred to as a frame) 3. As shown in FIG. 5 in particular, the frame 3 is, as described above, a box body (frame with an opening on one side) having a rectangular bottom portion 31 and a side wall (peripheral wall) 32 erected from the bottom portion 31, and has the accommodation space 33 surrounded by these. The accommodation space 33 is set to have a shape and dimensions such that the accommodation space 33 accommodates a plurality (a predetermined number) of negative electrode plates 7B with an electrolyte layer and the positive electrode plates 7C in a state of being alternately laminated with the solid electrolyte layers interposed therebetween, whereby the positioning holes 8Ba of the negative electrode plates 7B with an electrolyte layer and the positive electrode plates 7C communicate with each other, or the positioning holes 8Ba of the negative electrode plates 7B with an electrolyte layer communicate with each other and the positioning holes 8Ba of the positive electrode plates 7C communicate with each other. The shape and the dimensions of the accommodation space 33 are determined according to the shape or dimensions of the electrode plate for lamination, the perforation position, the number, the shape, or the dimensions of the positioning holes, even loading speed, and the like. The accommodation space 33 usually has a rectangular shape in a plan view similar to the electrode plate, and a depth thereof is appropriately determined according to the thickness and the number of electrode plates to be laminated. Inner dimensions of the frame 3 (the dimensions of the accommodation space 33) are set to be large than the dimensions of the electrode plate (in a case where the dimensions of the negative electrode plate 7B with an electrolyte layer and the positive electrode plate 7C are different from each other, the larger dimensions) to the extent that the communication hole is formed in the positioning holes, and for example, it is preferable that the inner dimensions are larger than the dimensions of the electrode plate by 0.1 to 1.0 mm in a longitudinal length (long side length) and by 0.1 to 1.0 mm in a lateral length (short side length).

A hole 34 (see FIG. 5) through which the positioning pin 42 passes is provided in the bottom portion 31 at a position corresponding to the positioning pin 42 erected on the positioning jig 4, which will be described below.

In the present invention, the frame is not limited to the above-described aspect and can be appropriately changed. For example, in a case where the electrode plates for lamination are laminated in a vertical direction, the frame can be a frame with openings on both sides, including side walls without a bottom portion.

Although not shown in FIGS. 3A to 5, the manufacturing apparatus 1 includes a frame transport device that transports the frame 3 from the opening and closing shutter 2C between the positioning jig 4 and the restricting member 5, which will be described below. The frame transport device is not particularly limited as long as the frame 3 can be transported, and examples thereof include a known transport device, various conveyors, a robot arm, and manual transport.

With the manufacturing apparatus 1 including the frame transport device, the frame 3 is relatively movable from below the opening and closing shutter 2C to the space between the positioning jig 4 and the restricting member 5, but in the present invention, a configuration may also be adopted in which a moving device is provided for each of the positioning jig and the restricting member to move the positioning jig and the restricting member relative to the frame. Examples of such a moving device include various transport devices.

It is preferable that the manufacturing apparatus 1 has the correction member 6 that corrects laminated portions of the electrode plates 7B and 7C, particularly the active material layers 8D and the solid electrolyte layers 8F, which are laminated in the accommodation space 33, to be flat. The correction member 6 can correct (maintain) the electrode plates to be flat or bring the electrode plates into contact with each other in a case where the electrode plates are curved, in a case where a space is formed between the laminated electrode plates, or the like, and thus contributes to the formation of the communication hole. Examples of the correction member 6 include a plate-shaped member having a flat surface and a block-shaped member, and a press machine or the like can also be used. The correction member 6 is configured to be able to press the electrode plates (temporarily laminated electrode plate group) that is connected to a known transport device, that is movable in an upward direction of the frame 3, and that is accommodated in the accommodation space 33. A pressing device that presses the laminated electrode plates 7B and 7C with the correction member 6 is not particularly limited, and examples thereof include a cam mechanism, a hydraulic piston, a press machine, a magnetic force, and pressing by a weight (gravity) of the correction member 6.

In the present invention, the correction member is not limited to the above-described aspect and can be appropriately changed. For example, the correction member may be integrated with the frame, or the restricting member or the positioning jig described below.

The manufacturing apparatus 1 includes the positioning jig 4 and the restricting member 5 that are relatively movable in the forward or rearward direction (up-down direction of the temporarily laminated electrode plate group) in the lamination direction of the temporarily laminated electrode plate group accommodated in the frame 3.

In the manufacturing apparatus 1, as shown in FIG. 3B, the positioning jig 4 and the restricting member 5 are configured such that the frame 3 is transported and moved by the frame transport device described above, and the positioning jig 4 and the restricting member 5 are installed at predetermined positions.

As shown in FIGS. 3A, 3B, and 5, the positioning jig 4 may be a member having the positioning pin 42 that is erected on a base 41 on a flat plate, and a cross-sectional shape perpendicular to an axis, an erection position, disposition, and the like of the positioning pin 42 are determined in accordance with a shape, a perforation position, disposition, and the like of the positioning hole 8Ba in the electrode plates 7B and 7C. In the manufacturing apparatus 1, a total of four positioning pins 42 are erected, one at each of corner portions of the rectangular base 41 having substantially the same size as the bottom portion 31 of the frame 3. In the manufacturing apparatus 1, among these, a pair of two positioning pins 42 erected at one short side end portion are used as pins for a negative electrode plate to be inserted into the positioning holes 8Ba of the electrode plates 7B, and a pair of two positioning pins 42 erected at the other short side end portion are used as pins for a positive electrode plate to be inserted into the positioning holes 8Ba of the electrode plates 7C.

A shape of the positioning pin 42 is not particularly limited as long as the positioning pin 42 can be inserted into the positioning hole 8Ba to position the electrode plate, but usually, as shown in FIG. 5 and FIG. 6A, it is preferable that the positioning pin 42 has a pin body portion (also referred to as a body portion) 42a having a diameter smaller than an inner diameter of the positioning hole 8Ba and a pointed tip portion (also referred to as a tapered portion) 42b that extends from one end of the pin body portion 42a. Cross-sectional shapes perpendicular to an axis of the pointed tip portion 42b and the pin body portion 42a are not particularly limited, and can be for example, circular, elliptical, polygonal, or star-shaped. The cross-sectional shape is preferably circular. As will be described below, the pointed tip portion 42b exhibits, with a peripheral side surface that gradually increases in diameter, a function of guiding the positioning pin 42 to be inserted into the communication hole, and even a function of assisting an overlapping position adjustment function of the pin body portion 42a. In addition, the pin body portion 42a is sequentially inserted into the communication hole from a tip of the pointed tip portion 42b to exhibit the overlapping position adjustment function of changing the electrode plate with the deviated overlapping position with an outer peripheral surface thereof coming into contact with an inner periphery (inner surface) of the positioning hole 8Ba and adjusting the electrode plate to a predetermined overlapping position. With the pointed tip portion 42b provided as above, the positioning pin 42 is easily inserted into the communication hole that appears in the temporarily laminated electrode plate group, and the electrode plates can be positioned with high accuracy while preventing breakage, damage, or the like of the base material extension portion 8B due to the insertion of the positioning pin 42.

An outer diameter of the pin body portion 42a is appropriately determined according to the inner diameter of the positioning hole 8Ba or the like, and can be set to, for example, 1.0 to 8.0 mm. From the viewpoint of the overlapping accuracy, a difference between the inner diameter of the positioning hole 8Ba and the outer diameter of the pin body portion 42a of the positioning pin 42 is set in the above-described range. A length of the pin body portion 42a may be a length that passes through the positioning hole 8Ba of the temporarily laminated electrode plate group, and is appropriately determined. In addition, the reduction ratio of the pointed tip portion 42c ((maximum outer diameter−minimum outer diameter)/length) is not particularly limited and is appropriately determined.

In the present invention, the positioning pin may have the pointed tip portion that gradually decreases in diameter and the pin body portion, and various changes can be made. For example, as shown in FIG. 6B, a structure having the pin body portion 42a, the pointed tip portion 42c that extends from one end of the pin body portion 42a, and a rod portion 42d that extends from the pointed tip portion 42c in the same direction may also be adopted. Regarding the positioning pin having the rod portion 42d, the positioning pin 42 is easily inserted into the communication hole because the pointed tip portion 42c enters the communication hole after the rod portion 42d enters the communication hole.

As shown in FIGS. 3A, 3B, and 5, the restricting member 5 may be a member having a pin receiving portion (pin receiving hole) 52 perforated in a base 51 on a flat plate, and a perforation position, disposition, and the like of the pin receiving portion 52 are determined in accordance with the erection position, the disposition, and the like of the positioning pin 42. The pin receiving portion 52 may be formed to allow the positioning pin 42 to be inserted thereinto, and is determined to have appropriate dimensions according to an outer diameter, an insertion amount, and the like of the pin receiving portion 52. In the manufacturing apparatus 1, the restricting member 5 is provided with a restricting surface 51b that comes into contact with an upper surface of the temporarily laminated electrode plate group when the restricting member 5 is placed on a side wall 32 of the frame 3. The restricting member 5 is configured basically the same as the positioning jig 4, except that the restricting member 5 has the pin receiving portion 52 instead of the positioning pin 42 and has the restricting surface 51b. Specifically, in the restricting member 5, a total of four pin receiving portions 52 are formed, one at each of corner portions of the rectangular base 51 having substantially the same size as the bottom portion 31 of the frame 3. The restricting member 5 is formed integrally with the above-described correction member 6. In the restricting surface 51b, portions (regions) located in the vicinity of short side end edges and facing the base material extension portion 8B (the positioning hole 8Ba) of the temporarily laminated electrode plate group respectively function as restricting portions 51a that restrict displacement of the base material extension portion 8B, and an intermediate portion that connects the two restricting portions 51a functions as the correction member 6.

A relative moving mechanism that allows the restricting member 5 to be relatively movable close to or away from the positioning jig 4 is not particularly limited, and various known moving devices (mechanisms) such as a cam mechanism and a hydraulic piston can be applied. It should be noted that a manual operation can also be adopted as the relative moving mechanism.

In the present invention, the positioning jig, the restricting member, and the correction member are not limited to the above-described aspects and can be appropriately changed. For example, the positioning jig and the restricting member may be movable with respect to the frame, and in this case, the transport device is the same as the above-described frame transport device.

In the present invention, the restricting member may be configured such that each restricting portion is provided as a separate body, and for example, the restricting member can be configured such that a restricting member for a negative electrode plate, which is disposed in a base material extension portion of a negative electrode plate with an electrolyte layer and accepts a pin for a negative electrode plate, and a restricting member for a positive electrode plate, which is disposed in a base material extension portion of a positive electrode plate and which accepts a pin for a positive electrode plate, are provided as separate bodies. In this case, the correction member may be connected to any one of the restricting member for a negative electrode or the restricting member for a positive electrode to be integrally configured, or may be provided as a separate body from the restricting member for a negative electrode or the restricting member for a positive electrode.

In addition, in a case where the positioning pins are inserted into the communication holes of the temporarily laminated electrode plate group from an upward direction to a downward direction opposite to that in FIG. 3, that is, from an opening side of the frame 3 toward the bottom portion 31, the restricting member and the correction member can be replaced with the bottom portion of the frame.

The manufacturing apparatus 1 may include an oscillating device that oscillates the frame 3 in the plane direction. The oscillating device may be any device that can oscillate the frame 3, and various oscillating devices can be applied, or the oscillating device may be manually operated. The oscillating device assists in the appearance of the communication hole by oscillating the frame 3 to move the electrode plates accommodated in the accommodation space 33 in the plane direction to adjust the overlapping positions. A known transport device is connected to the oscillating device, and the oscillating device is configured to be movable to a side surface or the bottom portion of the frame 3 and to oscillate the frame.

The manufacturing apparatus 1 may include an oscillating device that oscillates the frame 3 in the up-down direction or inverts the frame 3, instead of or in addition to the above-described oscillating device. The oscillating device may be any device capable of oscillating or inverting the frame in the up-down direction, and various oscillating devices or inversion devices can be applied, or the oscillating device may be manually operated. The oscillating device or the inversion device moves the electrode plates accommodated in the accommodation space in the up-down direction by oscillating or inverting the frame, thereby avoiding engagement between the positioning pin and the electrode plate in the main positioning step and assisting in completion of the insertion of the positioning pin. It is also suitable that the oscillating device or the inversion device is configured to be oscillatable or invertible in a state in which the positioning jig and the frame are integrated.

Each of devices constituting the manufacturing apparatus 1 may be formed of an appropriate material. It is preferable that a portion of the transport device or the like that comes into contact with the active material layer is formed of a resin, rubber, or the like to prevent damage to the active material layer.

The manufacturing apparatus 1 implements an aspect in which the positioning jig 4 is relatively moved from a lower side (bottom portion 31) of the frame 3 toward an upper side (opening side of the frame 3) to insert the positioning pin 42 into the communication hole, but in the present invention, an aspect in which the positioning jig is moved from the upper side toward the lower side of the frame to insert the positioning pin into the communication hole is also preferable. As a manufacturing apparatus capable of implementing this aspect, the bottom portion of the frame can be functioned as the restricting member and the correction member (the frame, the restricting member, and the correction member can be configured as an integrated member). Therefore, the manufacturing apparatus can be configured to not include the restricting member and the correction member, and the positioning jig can be configured to be movable relative to the frame. For example, a configuration can be adopted in which the positioning jig is installed at a predetermined position, and the frame integrated with the restricting member or the like is transported and moved to a position facing the positioning jig by the frame transport device. In this aspect, the correction member can be used as a separate member instead of being integrated with the frame, and for example, the correction member can be provided on the electrode plate (between the frame and the positioning jig).

The manufacturing apparatus according to the embodiment of the present invention can be a manufacturing apparatus configured by combining appropriate modifications of the above-described components such as the electrode plate group accommodation frame, the positioning jig, and the restricting member.

Next, as a suitable embodiment of the manufacturing method according to the embodiment of the present invention, an embodiment using the manufacturing apparatus 1 will be described including operations and actions of the manufacturing apparatus 1.

In the suitable embodiment of the manufacturing method (hereinafter, sometimes referred to as a suitable manufacturing method according to the embodiment of the present invention), the step of obtaining the above-described temporarily laminated electrode plate group and the step of performing the main positioning are performed, but another step can also be performed before, during, or after these steps. Specifically, in the suitable manufacturing method according to the embodiment of the present invention, various steps such as an electrode plate producing step, an electrode plate transporting step, the step of obtaining the temporarily laminated electrode plate group, and the step of performing the main positioning are performed in this order. Furthermore, after the step of performing the main positioning, various steps such as a fixing step, an isolation step, a lead wire welding step, and a sealing step in the housing can be performed in order. In addition, it is also preferable to appropriately perform a correcting step and an oscillating step (including an up-and-down oscillating step and an inverting step).

In the suitable manufacturing method according to the embodiment of the present invention, first, the negative electrode plate 7B with an electrolyte layer and the positive electrode plate 7C are produced as the electrode plates for lamination (electrode plate producing step).

The negative electrode plate 7B with an electrolyte layer and the positive electrode plate 7C corresponding to the electrode plate 7A for lamination can be produced according to a known method, and is usually produced by forming the active material layer 8D on both main surfaces of the above-described base material 8. Examples of a method for forming the active material layer 8D include a method of molding or forming a film (coating and drying) a composition containing the active material, and, as appropriate, an inorganic solid electrolyte, a binder, and other additives. The molding or forming method and conditions thereof can be appropriately determined.

To produce the negative electrode plate 7B with an electrolyte layer, the solid electrolyte layer 8F is produced (laminated and disposed) on both main surfaces of the active material layer 8D in the electrode plate 7A for lamination produced as described above. Various known methods can be applied as a method for producing the solid electrolyte layer 8F on the main surface of the active material layer 8D, and examples thereof include a method of molding or forming a film on the main surface of the active material layer 8D, and a method of transferring (pressure-bonding) the solid electrolyte layer 8F produced by the following method onto the main surface of the active material layer 8D.

In the manufacturing method according to the embodiment of the present invention, in a case where the solid electrolyte layer is used separately from the electrode plate 7A, the solid electrolyte layer is produced. A method of producing the solid electrolyte layer is the same as a method of producing the electrode plate, except that the solid electrolyte layer is molded or formed on the base material using a composition containing an inorganic solid electrolyte, and, as appropriate, a binder, and other additives. However, in a case of being used in the manufacturing method according to the embodiment of the present invention, the base material is peeled off from the solid electrolyte layer.

In the suitable manufacturing method according to the embodiment of the present invention, the produced electrode plate for lamination is then transported to the frame 3 (electrode plate transporting step).

Specifically, as shown in FIGS. 3A to 4, the negative electrode plates 7B with an electrolyte layer is placed on the conveyor 2A at regular intervals, and the positive electrode plates 7C are placed on the conveyor 2B at regular intervals. In this case, the two electrode plates are placed on the conveyors 2A and 2B in a state in which one main surface is directed upward, such that the base material extension portions 8B (the positioning hole 8Ba) are located on sides opposite to each other with respect to a long side direction of the electrode plates. In the suitable manufacturing method according to the embodiment of the present invention, as shown in FIGS. 3A and 3B, the electrode plates 7B and 7C are respectively placed on the conveyors 2A and 2B so that the base material extension portion 8B of the negative electrode plate 7B with an electrolyte layer is located on a positioning jig 4 side and the base material extension portion 8B of the positive electrode plate 7C is located on a side opposite to the positioning jig 4. In this state, both the conveyors 2A and 2B are driven to alternately transport the negative electrode plates 7B with an electrolyte layer and the positive electrode plates 7C onto the opening and closing shutter 2C. An alternate transport method is not particularly limited, and examples thereof include various methods such as a method of adjusting disposition positions of both the electrode plates placed on the conveyors 2A and 2B and an interval therebetween, and a method of intermittently driving the conveyors 2A and 2B.

In the suitable manufacturing method according to the embodiment of the present invention, a step of transporting (feeding) the electrode plates into the accommodation space 33 to obtain the temporarily laminated electrode plate group is then performed.

In performing this step, as shown in FIGS. 3B and 4, the frame 3 is transported to a position below the opening and closing shutter 2C (lower side in the direction of gravity) by the above-described frame transport device. In this state, a predetermined number of the electrode plates are transported and placed on the closed opening and closing shutter 2C, and then the opening and closing shutter 2C is opened to transport (feed) the electrode plates on the opening and closing shutter 2C to the frame 3 (accommodation space 33). The transport may be performed by transporting the electrode plates transferred to the opening and closing shutter 2C one by one or by transporting a plurality of electrode plates at a time.

As a result, a plurality (a predetermined number) of the negative electrode plates 7B with an electrolyte layer and the positive electrode plates 7C with the solid electrolyte layers interposed therebetween are alternately accommodated in the accommodation space 33 of the frame 3 such that the main surfaces thereof are in contact with each other. Here, since the dimensions of the accommodation space 33, the dimensions of the two electrode plates, the shape and inner diameter of the positioning hole 8Ba, and the like are set as described above, the electrode plates placed (accommodated) in the accommodation space 33 are temporarily positioned, and the positioning holes 8Ba that are arranged in the lamination direction in the electrode plate group having the same polarity do not completely deviate from other positioning holes 8Ba in the plane direction, and at least portions thereof overlap. As a result, the positioning holes 8Ba of the negative electrode plates 7B with an electrolyte layer communicate with each other (in an overlapping region) in the lamination direction (direction of gravity) with an interval therebetween, and the communication hole appears inside each positioning hole 8Ba. In addition, in the case of the positioning holes 8Ba of the positive electrode plates 7C, similarly, the positioning holes 8Ba communicate with each other with an interval therebetween in the lamination direction, and the communication hole appears inside each positioning hole 8Ba.

In this way, the temporarily laminated electrode plate group in which the positioning holes 8Ba communicate with each other is formed.

In the suitable manufacturing method according to the embodiment of the present invention, in a case where the electrode plate 7B or 7C for lamination is bent, in a case where a space is formed between the laminated electrode plates, or the like, it is preferable to correct the electrode plate 7B or 7C for lamination to be flat (correcting step). This correcting step can be performed by pressing the temporarily laminated electrode plate group with the correction member 6, but the pressing is released in the step of performing the main positioning described later. This correcting step can be performed in the step of obtaining the temporarily laminated electrode plate group, but can also be performed before or after the step of obtaining the temporarily laminated electrode plate group. In a case where the correcting step is performed before or during the step of obtaining the temporarily laminated electrode plate group, the appearance of the communication hole can be assisted or a size of the communication hole can be increased.

In the suitable manufacturing method according to the embodiment of the present invention, it is preferable to oscillate the frame 3 in the plane direction by the oscillating device as appropriate (oscillating step). As a result, the overlapping positions of the electrode plates accommodated in the accommodation space 33 can be adjusted, whereby the appearance of the communication hole can be assisted or the size of the communication hole can be increased. This oscillating step can be performed in the step of obtaining the temporarily laminated electrode plate group, but can also be performed before or after the step of obtaining the temporarily laminated electrode plate group.

In the suitable manufacturing method according to the embodiment of the present invention, it is preferable that the frame 3 is appropriately oscillated in the up-down direction or inverted (up-down oscillating step or inverting step), instead of or in addition to the above-described oscillating step. As a result, the electrode plates accommodated in the accommodation space 33 are moved in the up-down direction, thereby avoiding engagement between the positioning pin 42 and the electrode plate in the main positioning step and assisting in the completion of the insertion of the positioning pin 42. The up-down oscillating step or the inverting step can be performed during the main positioning step.

In the suitable producing method according to the embodiment of the present invention, the step of performing the main positioning is then performed.

In performing this step, as shown in FIG. 5, first, the frame 3 accommodating the temporarily laminated electrode plate group is transported by the above-described frame transport device to be located between the positioning jig 4 and the restricting member 5, which are disposed to be spaced apart in the direction of gravity, and then the restricting member 5 is placed on the frame 3 in a state in which the temporarily laminated electrode plate group is in contact with the restricting portion 51a of the restricting member 5. As a result, the base material extension portion 8B of the temporarily laminated electrode plate group is restricted by the restricting portion 51a. In addition, an axis of the positioning hole 8Ba (the communication hole) and the axis of the positioning pin 42 are located on a straight line along the direction of gravity. Axes of the hole 34 of the frame 3 and the pin receiving portion 52 of the restricting member 5 are also located on the above-described straight line.

Next, in this state, the relative moving mechanism is driven to relatively move the positioning jig 4 toward the restricting member 5. In this case, the positioning pin 42 of the positioning jig 4 first passes through the hole 34 of the frame 3 and the pointed tip portion 42b enters the communication hole, followed by the pin body portion 42a entering the communication hole, and finally reaching the pin receiving portion 52 of the restricting member 5, whereby the insertion of the positioning pin 42 into the positioning hole 8Ba (the insertion until the positioning pin 42 protrudes from the other opening side to one opening side of the communication hole) is completed. Here, the pointed tip portion 42b that first enters the communication hole guides the entry of the pin body portion 42a into the communication hole with the peripheral side surface that gradually increases in diameter, and assists in adjusting the overlapping position of the pin bod y portion 42a. Since the inner diameter of the positioning hole 8Ba and the outer diameter of the pin body portion 42a are set as described above, as the pin body portion 42a enters the communication hole following the pointed tip portion 42b, the outer peripheral surface thereof comes into contact with the inner peripheral surface of the positioning hole 8Ba, whereby the electrode plate with the deviated overlapping position can be changed in the plane direction (horizontal direction) and positioned at a predetermined overlapping position. Furthermore, in a process of inserting the positioning pin 42, by the restricting portion 51a that is disposed in a state of being in contact with the temporarily laminated electrode plate group, the variation of the base material extension portion 8B in the lamination direction (direction of gravity), particularly, the variation of the base material extension portion 8B located on a restricting member 5 side, that is, on one opening side (restricting portion 51a side) of the communication hole is restricted. As a result, the base material extension portion 8B is maintained in a horizontal state, and the positioning pin 42 quickly enters and is inserted into the communication hole without damaging the base material extension portion 8B or the like. Here, among the four positioning pins 42 erected on the base 41, the pair of two positioning pins 42 (pins for a negative electrode plate) erected at one end portion on the short side are inserted into the positioning holes 8Ba of the negative electrode plates 7B to achieve main positioning of the negative electrode plates 7B, and the pair of two positioning pins 42 (pins for a positive electrode plate) erected at one end portion on the short side are inserted into the positioning holes 8Ba of the positive electrode plates 7B to achieve main positioning of the positive electrode plates 7C.

In the above-described series of operations, a mechanism by which each individual electrode plate is positioned by the insertion of the positioning pin 42 is the same as the positioning mechanism described in each of the above-described patent documents. However, in the present invention, the electrode plates are continuously or intermittently sequentially positioned from the electrode plate positioned on the positioning jig 4 side to the electrode plate laminated on the restricting member 5 side by one insertion of the positioning pin 42.

In this way, the pin body portion 42a exhibits the overlapping position adjustment function. As a result, the plurality of electrode plates can be moved in the plane direction (a direction perpendicular to an insertion direction of the positioning pin 42) to adjust the overlapping positions of the electrode plates with high accuracy while preventing the base material extension portion 8B, particularly the positioning hole 8Ba, from being broken, damaged, or the like, and the temporarily laminated electrode plate group that has been temporarily positioned can be precisely subjected to main positioning.

With the suitable manufacturing method according to the embodiment of the present invention, the electrode plate group for a battery can be simply manufactured.

In the suitable manufacturing method according to the embodiment of the present invention, the following post-treatment step can be further performed on the electrode plate group for a battery manufactured as described above.

Examples thereof include a step of driving the relative moving mechanism to move the positioning jig 4 in a direction away from the restricting member 5 and pull out the positioning pin 42 from the positioning hole 8Ba, a step of cutting the positioning pin 42 inserted into the positioning hole 8Ba from the base 41, and a step of cutting the base material extension portion 8B, into which the positioning pin 42 is inserted, from the electrode plate 7A.

In addition, examples thereof include a step of taking out the electrode plate group for a battery from the accommodation space 33, a step of removing unnecessary layers on upper surfaces and lower surfaces of the electrode plate group for a battery to provide a substrate (current collector), a step of welding lead wires to a plurality of lead portions 8C in the electrode plates having the same polarity, a step of sealing the electrode plate group for a battery in the housing, and a step of pressing the electrode plate group for a battery.

In addition, a step of fixing the electrode plates constituting the electrode plate group for a battery may also be included before or after the post-treatment step. The fixing step is usually performed by sealing peripheral surfaces of the electrode plate group for a battery with various resins or the like.

The present invention is not limited to the suitable manufacturing method according to the embodiment of the present invention described above, and can be appropriately changed.

For example, in the suitable manufacturing method according to the embodiment of the present invention, the base material extension portions 8B of the positive electrode plates 7C and the negative electrode plates 7B are disposed on the sides opposite to each other with respect to the long side direction of the electrode plates and laminated. However, in the present invention, the base material extension portions of the positive electrode plates and the negative electrode plates can also be located on the same side with respect to the long side direction of the electrode plates and laminated, as in Example 1 described later. In this case, the positioning pin is inserted into the positioning holes of the positive electrode plate and the negative electrode plate to collectively position the positive electrode plate and the negative electrode plate.

In the suitable manufacturing method according to the embodiment of the present invention, the aspect in which the negative electrode plates 7B with an electrolyte layer and the positive electrode plates 7C are alternately laminated has been described, but in the present invention, as the electrode plates to be disposed at a lowest layer and an uppermost layer of the electrode plate group for a battery to be manufactured, an electrode plate in which the active material layer and even the solid electrolyte layer are provided on only one main surface of the base material can also be used. In a case where such an electrode plate is used, an electrode plate group for a battery of a laminated structure, which is suitable for assembly into an all-solid state secondary battery, can be manufactured with the completion of the step of performing the main positioning.

In addition, in the present invention, as the electrode plate for lamination of the electrode plate group for a battery to be manufactured, an electrode plate in which the active material layer and even the solid electrolyte layer are provided only on one main surface of the base material can also be used. In a case where such an electrode plate is used, it is not necessary to mix kinds of the electrode plates, that is, double-sided electrode plates and single-sided electrode plates, and the transport device can be simplified.

Furthermore, in the present invention, an aspect in which the positioning jig is moved from an upper side (opening side of the frame) to a lower side (bottom portion) of the frame to insert the positioning pin into the communication hole is also preferable. In this aspect, the bottom portion of the frame can function as the restricting member and the correction member. Therefore, the manufacturing method according to the above-described preferred aspect can be implemented by moving the positioning jig toward the bottom portion relative to the temporarily laminated electrode plate group that has been temporarily positioned in the accommodation space of the frame, without using the restricting member and the correction member.

Although the manufacturing apparatus 1 is used in the suitable manufacturing method according to the embodiment of the present invention, the manufacturing apparatus used in the manufacturing method according to the embodiment of the present invention is not limited to the manufacturing apparatus 1, and a manufacturing apparatus configured by combining appropriate modifications of the above-described components, such as the electrode plate group accommodation frame, the positioning jig, and the restricting member, can be used.

As described above, with the manufacturing method and the manufacturing apparatus of an electrode plate group for a battery according to the embodiment of the present invention, a plurality of electrode plates can be laminated within a short lamination time while maintaining (controlling) high overlapping accuracy, and the electrode plate group for a battery can be manufactured with high accuracy and high productivity.

In addition, even in a case where a negative electrode plate larger than the positive electrode plate is used, high overlapping accuracy can be maintained, and an electrode plate group for a battery in which the occurrence of a short circuit can be highly suppressed can be manufactured with high productivity. In particular, since the negative electrode plate can be set to a minimum size with respect to the positive electrode plate from the viewpoint of preventing the occurrence of a short circuit, it is possible to manufacture an electrode plate group for a battery capable of achieving a high energy density with high productivity while suppressing the occurrence of a short circuit.

Furthermore, in the manufacturing method and the manufacturing apparatus of an electrode plate group for a battery according to the embodiment of the present invention, the plurality of electrode plates can be collectively positioned, so that high productivity can be achieved while maintaining high overlapping accuracy even in a case where the number of electrode plates to be laminated is increased. Therefore, in the present invention, an operational effect is more remarkable as the number of the electrode plates to be laminated is increased.

In the present invention for manufacturing a electrode plate group for a battery for an all-solid state secondary battery, in the above-described suitable embodiment in which the negative electrode plate with an electrolyte layer is used as the negative electrode plate and the solid electrolyte layer, the productivity of the electrode plate group for a battery can be further increased.

The present invention, in which the electrode plates for lamination are collectively positioned using the restricting member 5 and the positioning jig 4 as described above, can be applied for manufacturing of an electrode plate group for a battery in which the number of electrode plates for lamination laminated is increased, an electrode plate group for a battery using an electrode plate for lamination in which a surface area of the main surface of the active material layer is increased, and even an electrode plate group for a battery using an electrode plate for lamination in which an application amount of the active material layer (mass of the active material layer) is increased, without impairing the above-described excellent operational effects, by appropriately changing the perforation positions of the positioning holes of the electrode plates, the number of perforations, and the like.

### EXAMPLES

Hereinafter, the present invention will be described in more detail based on examples; however, the present invention is not to be construed as being limited thereto. “Parts” and “%” that represent compositions in the following examples are in terms of mass unless particularly otherwise described. In the present invention, “room temperature” means 25° C.

In the examples, the frame 3, the positioning jig 4, and the restricting member 5 in the manufacturing apparatus 1 shown in FIGS. 3A and 3B were produced to manufacture an electrode plate group for a battery, and the overlapping accuracy in the obtained electrode plate group for a battery and a time required for the positioning were measured.

The production of the electrode plate for lamination and the manufacturing of the electrode plate group for a battery were performed in an argon atmosphere or a dry atmosphere having a dew point of −60° C. or lower.

### <Production of Frame 3A (for Example 1 and Comparative Examples)>

A frame 3A having the following dimensions was produced using aluminum metal. Two holes 34 were perforated in the bottom portion 31 in a thickness direction at positions corresponding to the positioning pins 42 of a positioning jig 4A.

Inner dimensions of accommodation space 33: Long side (longitudinal) 121.0 mm, short side (lateral) 43.0 mm

### <Production of Frame 3B (for Examples 2 to 4)>

A frame 3B was manufactured in the same manner as the frame 3A, except that four holes 34 were perforated in the bottom portion 31 in the thickness direction at positions corresponding to the positioning pins 42 of a positioning jig 4B.

### <Production of Positioning Jig 4A (for Example 1 and Comparative Examples)>

The positioning jig 4A having the following dimensions was produced using aluminum metal.

Dimensions of base 41: Same as outer dimension of the frame 3A

Positioning pin 42: Two pins are erected at an interval of 30 mm (center-to-center distance) along the short side at positions corresponding to the positioning holes 8Ba on one short side of the base 41

Pin body portion 42a: Diameter (outer diameter) 4.0 mm

### <Production of Positioning Jig 4B (for Examples 2 to 4)>

The positioning jig 4B was manufactured in the same manner as the positioning jig 4A, except that a total of four positioning pins 42 were erected at positions corresponding to the positioning holes 8Ba on each of both short sides of the base 41, two on each side, with an interval of 30 mm along the short sides.

### <Production of Restricting Member 5A (for Examples 1 and Comparative Examples)>

A restricting member 5A having the following dimensions was produced using aluminum metal.

Dimensions of base 51: Same as the outer dimensions of the frame 3A

Pin receiving portion 52: Two pin receiving portions are formed at positions corresponding to the positioning pins 42 of the positioning jig 4A

Pin receiving portion 52: Diameter 4.1 mm

Four end edges of the base 51 were cut to cause the restricting surface 51b (height: 40 mm) having the same dimensions as the inner dimensions of the accommodation space 33 to protrude.

### <Production of Restricting Member 5B (for Examples 2 to 4)>

A restricting member 5B was manufactured in the same manner as the restricting member 5A, except that a total of four pin receiving portions 52 were provided at positions corresponding to the positioning pins 42 of the positioning jig 4B, each on both short sides of the base 51.

Next, the negative electrode plate 7B with an electrolyte layer and the positive electrode plate 7C were produced as the electrode plates 7A for lamination.

<Production of Negative Electrode Plate 7B with Electrolyte Layer>

### (Production of Base Material)

A base material having the following dimensions was cut out from a stainless steel foil having a thickness of 10 μm (hereinafter, simply referred to as a stainless steel foil) such that the base material had the two base material extension portions 8B at both ends of one short side end edge and one lead portion 8C at a center of the other short side end edge.

Dimensions of active material layer formation region 8A: Long side 100.0 mm, short side of 42.0 mm

Outer dimensions of base material (negative electrode plate) including base material extension portion 8B and lead portion 8C: Long side 120.0 mm, short side 42.0 mm

Length in long side direction of base material extension portion 8B and lead portion 8C: 10.0 mm

Inner diameter of positioning hole 8Ba perforated in base material extension portion 8B: 4.1 mm

Distance between positioning holes 8Ba in short side direction: 30 mm

### (Production of Negative Electrode Plate)

A negative electrode mixture-containing paste was prepared by using 53 parts by mass of natural graphite, which is a negative electrode active material, 45 parts by mass of an argyrodite sulfide solid electrolyte (Li₆PS₅Cl), 2 parts by mass (solid content conversion value) of a rubber-based binder, and a tetralin-anisole mixed solvent. Next, the obtained negative electrode mixture-containing paste was applied onto each of both surfaces (active material layer formation region 8A) of the above-described base material (current collector) and dried so that a film thickness after the application and drying was 130 μm, whereby a negative electrode plate having a negative electrode active material layer on both surfaces was produced.

### (Production of Solid Electrolyte Layer)

A solid electrolyte-containing paste was prepared by using 98 parts by mass of an argyrodite sulfide solid electrolyte (Li₆PS₅Cl), 2 parts by mass (solid content conversion value) of a rubber-based binder, and a tetralin-anisole mixed solvent. Next, the obtained solid electrolyte-containing paste was applied onto one surface of a stainless steel foil having a thickness of 10 μm and dried so that a film thickness after the application and drying was 120 m. In this way, the above-described negative electrode active material layer and two laminates of the solid electrolyte layer and the stainless steel foil having the same dimensions on the long and short sides were produced.

(Production of Negative Electrode Plate 7B with Electrolyte Layer)

The solid electrolyte layer of each laminate was overlapped on each negative electrode active material layer of the produced negative electrode plate and subjected to a pressing treatment, and then the stainless steel foil was peeled off from the solid electrolyte layer. The application amounts (mass per unit area) of the negative electrode active material layer and the solid electrolyte layer were not changed (decreased) by the pressing treatment.

In this way, a negative electrode plate 7B with an electrolyte layer (referred to as “negative electrode plate with an active material layer” in Table 1) shown in FIG. 1C was produced.

### <Production of Positive Electrode Plate 7C>

### (Production of Base Material)

A base material having the following dimensions was cut out from a stainless steel foil having a thickness of 10 μm such that the base material had the two base material extension portions 8B at both ends of one short side end edge and one lead portion 8C at the center of the other short side end edge.

Dimensions of active material layer formation region 8A: Long side 96.0 mm, short side of 40.0 mm

Outer dimensions of base material (positive electrode plate) including base material extension portion 8B and lead portion 8C: Long side 120.0 mm, short side 40.0 mm

Length in long side direction of base material extension portion 8B and lead portion 8C: 12.0 mm

Inner diameter of positioning hole 8Ba perforated in base material extension portion 8B: 4.1 mm

Distance between positioning holes 8Ba in short side direction: 30 mm

### (Production of Positive Electrode Plate 7C)

A positive electrode mixture-containing paste was prepared by using 66 parts by mass of a positive electrode active material NCM523 (LiNi_{0.5}Co_{0.2}Mn_{0.3} particles coated on surfaces with LiNbO₃), 30 parts by mass of an argyrodite sulfide solid electrolyte (Li₆PS₅Cl), 3 parts by mass of VGCFT (carbon fiber manufactured by SHOWA DENKO K.K.) as a conductive auxiliary agent, 1 part by mass of a rubber-based binder (solid content conversion value), and a tetralin-anisole mixed solvent. Next, the obtained positive electrode mixture-containing paste was applied onto each of both surfaces (active material layer formation region 8A) of the above-described base material (current collector) and dried so that a film thickness after the application and drying was 90 μm. In this way, the positive electrode plate 7C corresponding to the electrode plate 7A shown in FIG. 1B, which had the positive electrode active material layer on both surfaces, was produced.

### Example 1

Using the produced negative electrode plates 7B with an electrolyte layer and positive electrode plates 7C, ten negative electrode plates 7B with an electrolyte layer and ten positive electrode plates 7C were alternately laminated in a disposition (single-sided extraction) in which the base material extension portions 8B of the both electrode plates 7B and 7C were located on the same side in the long side direction of the electrode plates, thereby manufacturing an electrode plate group for a battery of Example 1.

Specifically, ten negative electrode plates 7B with an electrolyte layer and ten positive electrode plates 7C were alternately laminated and accommodated by being manually placed one by one in the accommodation space 33 of the frame 3A in this order. As a result, the electrode plates 7B and 7C were temporarily positioned by the accommodation space 33, and the communication hole in which the positioning holes 8Ba perforated in the respective base material extension portions 8B of the electrode plates 7B and 7C communicated with each other in the lamination direction appeared. In this manner, a temporarily laminated electrode plate group consisting of ten electrode plates 7B and ten electrode plates 7C was obtained. Since no bend was observed in the electrode plates 7B and 7C and no space was observed between the electrode plates in the temporarily laminated electrode plate group, in Example 1, the step of correcting the electrode plate to be flat was not performed.

Next, the restricting member 5A was placed on the frame 3A accommodating the obtained temporarily laminated electrode plate group, and the positioning jig 4A was disposed below the frame 3A. At this time, a variation of the base material extension portion 8B of the temporarily laminated electrode plate group in the vertical direction was restricted by the restricting portion 51a. In addition, the axis of the communication hole that appeared in the positioning hole 8Ba, the axis of the positioning pin 42 erected on the positioning jig 4A, and the pin receiving portion 52 of the restricting member 5A were located on a vertical line. In this state, the positioning jig 4A was manually moved upward toward the restricting member 5A at a speed of about 3 cm/min, and the positioning pin 42 was inserted into the communication hole, and finally advanced to the pin receiving portion 52 of the restricting member 5A. In this way, a total of 20 electrode plates 7B and 7C were collectively positioned, thereby manufacturing the electrode plate group for a battery of Example 1.

### Example 2

An electrode plate group for a battery of Example 2 corresponding to the electrode plate group 9 for a battery shown in FIGS. 2A and 2B in the same manner as in the manufacturing method of the electrode plate group for a battery of Example 1, except that, in the manufacturing method of the electrode plate group for a battery of Example 1, the negative electrode plates 7B with an electrolyte layer and the positive electrode plates 7C were alternately laminated in the accommodation space 33 of the frame 3B used instead of the frame 3A in a disposition (double-sided extraction) in which the respective base material extension portions 8B thereof were located on the sides opposite to each other in the long side direction of the electrode plates, and a group of the negative electrode plates 7B with an electrolyte layer and a group of the positive electrode plates 7C were separately subjected to the main positioning using the positioning jig 4B and the restricting member 5B instead of the positioning jig 4A and the restricting member 5A.

### Example 3

An electrode plate group for a battery of Example 3 was manufactured in the same manner as in the manufacturing method of the electrode plate group for a battery of Example 2, except that, in the manufacturing method of the electrode plate group for a battery of Example 2, 20 negative electrode plates 7B with an electrolyte layer and 20 positive electrode plates 7C were alternately laminated.

### Example 4

An electrode plate group for a battery of Example 4 was manufactured in the same manner as in the manufacturing method of the electrode plate group for a battery of Example 2, except that, in the manufacturing method of the electrode plate group for a battery of Example 2, 40 negative electrode plates 7B with an electrolyte layer and 40 positive electrode plates 7C were alternately laminated.

### Comparative Example 1

Manufacturing of an electrode plate group for a battery was attempted in the same manner as in the manufacturing method of the electrode plate group for a battery of Example 1, except that, in the manufacturing method of the electrode plate group for a battery of Example 1, the restricting member 5 was not used. However, although the electrode plates 7B and 7C could be temporarily positioned, the positioning pin 42 could not be inserted into the positioning hole 8Ba (communication hole), and the electrode plate group for a battery could not be manufactured.

### Comparative Example 2

An electrode plate group for a battery of Comparative Example 2 was manufactured in the same manner as in the manufacturing method of the electrode plate group for a battery of Example 1, except that, in the manufacturing method of the electrode plate group for a battery of Example 1, the positioning pin 42 of the positioning jig 4A was alternately inserted into the positioning holes 8Ba of the negative electrode plates 7B with an electrolyte layer and the positive electrode plates 7C manually one by one to laminate a total of 20 plates.

In Comparative Example 2, the frame 3A was disposed on the positioning jig 4A in advance, and the restricting member 5A was disposed on the positioning hole 8Ba each time one electrode plate 1 was disposed in the accommodation space 33 of the frame 3A. Each time the positioning pin 42 was inserted into the positioning hole 8Ba for each electrode plate, the restricting member 5 was removed in order to dispose (accommodate) the next electrode plate.

### Comparative Example 3

Manufacturing of an electrode plate group for a battery was attempted in the same manner as in the manufacturing method of the electrode plate group for a battery of Example 1, except that, in the manufacturing method of the electrode plate group for a battery of Example 1, the inner dimensions (dimensions of the accommodation space 33) of the frame 3A were changed to a long side of 120.0 mm and a short side of 42.0 mm. However, a predetermined number of the electrode plates 7B and 7C could not be accommodated (temporarily positioned) in the accommodation space 33 of the frame 3A, and the temporarily laminated electrode plate group could not be obtained. As a result, the positioning pin 42 could not be inserted into the positioning hole 8Ba, and the electrode plate group for a battery could not be manufactured.

### Comparative Example 4

Manufacturing of an electrode plate group for a battery was attempted in the same manner as in the manufacturing method of the electrode plate group for a battery of Example 1, except that, in the manufacturing method of the electrode plate group for a battery of Example 1, the frame 3A was not used. However, the communication hole did not appear inside the positioning hole 8Ba (the temporary positioning could not be performed), and the temporarily laminated electrode plate group could not be obtained. As a result, the positioning pin 42 could not be inserted into the positioning hole 8Ba, and the electrode plate group for a battery could not be manufactured.

### <Evaluation of Overlapping Accuracy>

The overlapping accuracy of the manufactured electrode plate group for a battery was evaluated by measuring a margin (residual) amount (clearance) of the positive electrode plate 7C up to an overlapping position allowable limit position of the positive electrode plate 7C with respect to the negative electrode plate 7B with an electrolyte layer. The results are shown in Table 1.

In this evaluation, the overlapping position allowable limit position of the positive electrode plate 7C was set to a position of each end edge of the long side and the short side of (the active material layer formation region 8A of) the negative electrode plate 7B with an electrolyte layer, that is, a position where (the active material layer formation region 8A of) the positive electrode plate 7C did not protrude from (the active material layer formation region 8A of) the negative electrode plate 7B with an electrolyte layer, from the viewpoint of preventing the occurrence of a short circuit. In a case where the positive electrode plate 7C and the negative electrode plate 7B with an electrolyte layer are laminated such that center lines thereof in the short side direction coincide with each other, each long side end edge of the positive electrode plate 7C has a margin of 1 mm in the short side direction with respect to the negative electrode plate 7B with an electrolyte layer. Therefore, in this evaluation, a larger clearance indicates higher overlapping accuracy in laminating the electrode plates for lamination.

Specifically, a long side end portion of the laminated electrode plate group was observed as an X-ray transmission image with a high-resolution 3D X-ray microscope: nano 3DX (trade name, manufactured by Rigaku Corporation) in a direction perpendicular to the lamination direction. In the X-ray transmission image, outside the long side end portion of (the active material layer formation region 8A of) the negative electrode plate 7B directly below, the long side end portion of (the active material layer formation region 8A of) the negative electrode plate 7B, deviated further outward, of the negative electrode plate 7B located further below could be observed. In the obtained X-ray transmission image, for each of both sides of the long side end portion, a margin amount (clearance) of the positive electrode plate 7C was evaluated by measuring the gap distance (deviation amount) between (the active material layer formation regions 8A of) the negative electrode plate and the positive electrode plate at a point where the positive electrode plate and the negative electrode plate were closest to each other, adding minimum deviation amounts thus obtained, and dividing the sum by 2.

In Comparative Examples 1, 3, and 4, since the electrode plate groups for a battery could not be manufactured, the overlapping accuracy could not be evaluated, and is indicated by “X” in Table 1.

### <Evaluation of Productivity>

In the manufacturing of the electrode plate groups for a battery in Examples 1 to 4 and Comparative Example 2, a time required for laminating a predetermined number of the negative electrode plates 7B with an electrolyte layer and the positive electrode plates 7C on each other to perform the main positioning (the positioning pin 42 was inserted into the communication hole without damage or the like to the base material extension portion 8B and reached the pin receiving portion 52) was measured from the start of movement of the positioning jig 4. A time obtained by converting this measurement time into a time required for alternately laminating a total of 20 plates, ten each of the negative electrode plates 7B with an electrolyte layer and the positive electrode plates 7C, to perform the main positioning (actual positioning time/(20 plates/actual number of laminated plates)) was defined as “time required for positioning 20 electrode plates”. The results are shown in Table 1.

In Comparative Examples 1, 3, and 4, since the electrode plate groups for a battery could not be manufactured as described above, this test was not conducted (indicated by “X” in Table 1).

### <Evaluation of Damage to Active Material Layer and Solid Electrolyte Layer>

For the electrode plate group for a battery manufactured in Examples 1 to 4 and Comparative Example 2, visual inspection was performed to check for any defects such as damage in the negative electrode active material layer and the solid electrolyte layer of the negative electrode plate 7B with an electrolyte layer. The results are shown in Table 1. This test is a reference test for evaluating whether or not the electrode plate group for a battery can be manufactured without defects in the active material layer.

In Comparative Examples 1, 3, and 4, since the electrode plate groups for a battery could not be manufactured as described above, this test was not conducted (indicated by “X” in Table 1).

TABLE 1

| | | Example | | | | Comparative Example | | | |
|---|---|---|---|---|---|---|---|---|---|
| | | 1 | 2 | 3 | 4 | 1 | 2 | 3 | 4 |
| Disposition of base material | | Single- | Double- | Double- | Double- | Single- | Single- | Single- | Single- |
| extension portion | | sided | sided | sided | sided | sided | sided | sided | sided |
| Number of electrode plates | | 20 | 20 | 40 | 80 | 20 | 1 | 20 | 20 |
| inserted into positioning | | | | | | | | | |
| pin at once | | | | | | | | | |
| Restricting member | | Present | Present | Present | Present | Absent | Present | Present | Present |
| | Diameter of | 4.1 mm | 4.1 mm | 4.1 mm | 4.1 mm | — | 4.1 mm | 4.1 mm | 4.1 mm |
| | pin receiving | | | | | | | | |
| | portion | | | | | | | | |
| Inner diameter of | | 4.1 mm | 4.1 mm | 4.1 mm | 4.1 mm | 4.1 mm | 4.1 mm | 4.1 mm | 4.1 mm |
| positioning hole of | | | | | | | | | |
| electrode plate | | | | | | | | | |
| Outer diameter of | | 4.0 mm | 4.0 mm | 4.0 mm | 4.0 mm | 4.0 mm | 4.0 mm | 4.0 mm | 4.0 mm |
| positioning pin (pin | | | | | | | | | |
| body portion) | | | | | | | | | |
| | Difference | 0.1 mm | 0.1 mm | 0.1 mm | 0.1 mm | 0.1 mm | 0.1 mm | 0.1 mm | 0.1 mm |
| | from inner | | | | | | | | |
| | diameter of | | | | | | | | |
| | positioning | | | | | | | | |
| | hole | | | | | | | | |
| Frame | | Present | Present | Present | Present | Present | Present | Present | Absent |
| | Inner | 43.0 × 121.0 | 43.0 × 121.0 | 43.0 × 121.0 | 43.0 × 121.0 | 43.0 × 121.0 | 43.0 × 121.0 | 42.0 × 120.0 | — |
| | dimensions | | | | | | | | |
| | (mm) | | | | | | | | |
| Outer dimensions of | | 42.0 × 120.0 | 42.0 × 120.0 | 42.0 × 120.0 | 42.0 × 120.0 | 42.0 × 120.0 | 42.0 × 120.0 | 42.0 × 120.0 | 42.0 × 120.0 |
| negative electrode plate | | | | | | | | | |
| with active material | | | | | | | | | |
| layer (mm) | | | | | | | | | |
| | Difference | 1.0 × 1.0 | 1.0 × 1.0 | 1.0 × 1.0 | 1.0 × 1.0 | 1.0 × 1.0 | 1.0 × 1.0 | 0.0 × 0.0 | — |
| | from inner | | | | | | | | |
| | dimensions of | | | | | | | | |
| | frame (mm) | | | | | | | | |

| | | | | | | | | |
|---|---|---|---|---|---|---|---|---|
| Margin amount | 0.2 | 0.5 | 0.5 | 0.5 | X | 0.2 | X | X |
| (clearance) (mm) | | | | | | | | |
| Time required for | 5 | 5 | 6 | 8 | X | 240 | X | X |
| positioning 20 electrode | | | | | | | | |
| plates (sec) | | | | | | | | |
| Presence or absence of | Absent | Absent | Absent | Absent | X | Absent | X | X |
| damage to electrode | | | | | | | | |
| plate end portion | | | | | | | | |

The following can be seen from the results shown in Table 1.

In Comparative Example 1 in which the restricting member 5A was not used, the negative electrode plates 7B with an electrolyte layer and the positive electrode plates 7C could be temporarily positioned, but the positioning pins 42 could not be collectively inserted into the communication hole of the negative electrode plate 7B with an electrolyte layer and the positive electrode plate 7C. In addition, in Comparative Example 2 in which the negative electrode plates 7B with an electrolyte layer and the positive electrode plates 7C were alternately positioned one by one using the restricting member 5A each time, the overlapping accuracy was sufficient, but the time required for lamination was significantly long, resulting in inferior productivity. Furthermore, in Comparative Example 3 in which the inner dimensions of the accommodation space 33 of the frame 3A were set to the same dimensions as the negative electrode plate 7B with an electrolyte layer and the positive electrode plate 7C, a predetermined number of the negative electrode plates 7B with an electrolyte layer and the positive electrode plates 7C could not be accommodated in the accommodation space 33. In addition, in Comparative Example 4 in which the frame 3A was not used, the communication hole could not appear in the positioning holes 8Ba, and the negative electrode plates 7B with an electrolyte layer and the positive electrode plates 7C could not even be temporarily positioned in the first place.

Contrary to this, in Examples 1 to 4 in which the positioning pins 42 were collectively inserted in the step of performing the main positioning into the communication hole that had appeared in the step of obtaining the temporarily laminated electrode plate group using the frame 3, the positioning jig 4, and the restricting member 5, it can be seen that the negative electrode plates 7B with an electrolyte layer and the positive electrode plates 7C can be alternately laminated with high overlapping accuracy even within a short time required for lamination, and furthermore, damage to the active material layer and the solid electrolyte layer can be prevented.

From the above results, it can be seen that the manufacturing method and the manufacturing apparatus of an electrode plate group for a battery according to the embodiment of the present invention can manufacture the electrode plate group for a battery with high accuracy and high productivity.

The present invention has been described using the embodiment. However, unless specified otherwise, any of the details of the above description is not intended to limit the present invention and can be construed in a broad sense within a range not departing from the concept and scope of the present invention disclosed in the accompanying claims.
1: manufacturing apparatus of electrode plate group for a battery
2: electrode plate transport device
2A, 2B: conveyor
2C: opening and closing shutter
3: electrode plate group accommodation frame
31: bottom portion
32: side wall
33: accommodation space
34: hole
4: positioning jig
41: base
42: positioning pin
42a: pin body portion
42b, 42c: pointed tip portion
42d: rod portion
5: restricting member
51: base
51a: restricting portion
51b: restricting surface
52: pin receiving portion
6: correction member
7A: electrode plate for lamination
7B: negative electrode plate with an electrolyte layer
7C: positive electrode plate
8: base material
8A: active material layer formation region
8B: base material extension portion
8Ba: positioning hole
8C: lead portion
8D: active material layer
8E: insulating portion
8F: solid electrolyte layer
9: electrode plate group for a battery

What is claimed is:

1. A manufacturing method of an electrode plate group for a battery that is obtained by alternately laminating a plurality of rectangular positive electrode plates and a plurality of rectangular negative electrode plates with solid electrolyte layers interposed therebetween, the manufacturing method comprising:
a step of alternately placing the rectangular positive electrode plates and the rectangular negative electrode plates, each having a positioning hole, with the solid electrolyte layers interposed therebetween to be temporarily positioned, thereby obtaining a temporarily laminated electrode plate group in which the positioning holes communicate with each other; and
a step of inserting a positioning pin into a communication hole, in which the positioning holes communicate with each other, while restricting a variation in a lamination direction of one opening side of the communication hole until the positioning pin protrudes from the other opening side to the one opening side of the communication hole, thereby performing main positioning of the rectangular positive electrode plates and the rectangular negative electrode plates constituting the temporarily laminated electrode plate group.

2. The manufacturing method according to claim 1,
wherein, in the step of performing the main positioning, the rectangular positive electrode plates and the rectangular negative electrode plates are moved in a direction perpendicular to an insertion direction of the positioning pin by the insertion of the positioning pin to perform the main positioning.

3. The manufacturing method according to claim 1,
wherein the positioning pin includes a pin body portion having a diameter smaller than an inner diameter of the positioning hole, and a pointed tip portion extending from one end of the pin body portion.

4. The manufacturing method according to claim 3,
wherein, in the step of performing the main positioning, the pin body portion is inserted into the communication hole while being guided by the pointed tip portion.

5. The manufacturing method according to claim 1,
wherein at least one of the rectangular positive electrode plate or the rectangular negative electrode plate used in the step of obtaining the temporarily laminated electrode plate group has a solid electrolyte layer on both main surfaces of an active material layer.

6. The manufacturing method according to claim 1,
wherein, in the step of obtaining the temporarily laminated electrode plate group, the laminated rectangular positive electrode plates and rectangular negative electrode plates are corrected to be flat.

7. The manufacturing method according to claim 1,
wherein the rectangular positive electrode plate and/or the rectangular negative electrode plate used in the step of obtaining the temporarily laminated electrode plate group has a base material extension portion having the positioning hole in at least one side edge on a short side of an active material layer.

8. The manufacturing method according to claim 7,
wherein the rectangular positive electrode plate and/or the rectangular negative electrode plate used in the step of obtaining the temporarily laminated electrode plate group has two or more base material extension portions.

9. The manufacturing method according to claim 7,
wherein the base material extension portion extends to both side edges on the short side of the active material layer.

10. The manufacturing method according to claim 1,
wherein, in the step of obtaining the temporarily laminated electrode plate group, the rectangular positive electrode plates and the rectangular negative electrode plates are alternately laminated and then oscillated in a direction perpendicular to the lamination direction to assist in the temporary positioning.

11. A manufacturing apparatus of an electrode plate group for a battery that is obtained by alternately laminating a plurality of rectangular positive electrode plates and a plurality of rectangular negative electrode plates with solid electrolyte layers interposed therebetween, the manufacturing apparatus comprising:
an electrode plate group accommodation frame that has an accommodation space for accommodating the rectangular positive electrode plates and the rectangular negative electrode plates, each having a positioning hole, in a state of being alternately laminated with the solid electrolyte layers interposed therebetween, in which the rectangular positive electrode plates and the rectangular negative electrode plates are temporarily positioned by being accommodated in the accommodation space to obtain a temporarily laminated electrode plate group in which the positioning holes communicate with each other;
a positioning jig that is provided to be relatively movable forward or rearward in a lamination direction of the temporarily laminated electrode plate group and on which a positioning pin that is inserted into the positioning hole is erected; and
a restricting member that is relatively movable to a position facing the positioning jig across the electrode plate group accommodation frame, that is provided to be relatively movable close to and away from the positioning jig, and that has a restricting portion that restricts a variation in the lamination direction of one opening side of a communication hole in which the positioning holes communicate with each other, and a pin receiving portion that is provided in the restricting portion and receives the positioning pin.

12. The manufacturing apparatus according to claim 11, further comprising:
an electrode plate transport device that transports the rectangular positive electrode plates and rectangular negative electrode plates alternately into the accommodation space with the solid electrolyte layers interposed therebetween; and
a frame transport device that transports the electrode plate group accommodation frame between the positioning jig and the restricting member.

13. The manufacturing apparatus according to claim 11,
wherein the positioning pin includes a pin body portion having a diameter smaller than an inner diameter of the positioning hole, and a pointed tip portion extending from one end of the pin body portion.

14. The manufacturing apparatus according to claim 11,
wherein at least one of the rectangular positive electrode plate or the rectangular negative electrode plate accommodated in the electrode plate group accommodation frame has a solid electrolyte layer on both main surfaces of an active material layer.

15. The manufacturing apparatus according to claim 11, further comprising:
a correction member that corrects the laminated rectangular positive electrode plates and rectangular negative electrode plates to be flat.

16. The manufacturing apparatus according to claim 11,
wherein the rectangular positive electrode plate and/or the rectangular negative electrode plate accommodated in the electrode plate group accommodation frame has a base material extension portion having the positioning hole in at least one side edge on a short side of an active material layer.

17. The manufacturing apparatus according to claim 16,
wherein the rectangular positive electrode plate and/or the rectangular negative electrode plate accommodated in the electrode plate group accommodation frame has two or more base material extension portions.

18. The manufacturing apparatus according to claim 16,
wherein the base material extension portion extends to both side edges on the short side of the active material layer.

19. The manufacturing apparatus according to claim 11, further comprising:
an oscillating device that oscillates the electrode plate group accommodation frame in a direction perpendicular to the lamination direction of the rectangular positive electrode plates and the rectangular negative electrode plates.
